(19) United States
(12) Patent Application Publication
(10) Pub. No.: US 2025/0063588 A1
(43) Pub. Date: Feb. 20, 2025

(54) USER EQUIPMENT PERFORMANCE IN CARRIER AGGREGATION SCENARIOS

(71) Applicant: QUALCOMM Incorporated, San Diego, CA (US)

(72) Inventors: Akash KUMAR, Hyderabad (IN); Kadiyala ABHIRAM, HYDERABAD (IN); Eswar Venkata Narasimha Muthyala Prasad BAHADURSHA, Hyderabad (IN)

(21) Appl. No.: 18/451,781

(22) Filed: Aug. 17, 2023

(51) Int. Cl. H04W 72/542; H04B 7/06; H04L 5/00; H04W 24/10

(52) U.S. Cl. CPC H04W 72/542; H04B 7/0608; H04L 5/0051; H04L 5/0098; H04W 24/10; H04L 25/0204; H04W 28/0278

(57) ABSTRACT

Methods, systems, and devices for wireless communication are described. A user equipment (UE) may receive a carrier aggregation (CA) configuration including at least a primary component carrier (PCC) and a secondary component carrier (SCC), where the PCC is configured for frequency domain duplexed (FDD) communications and the SCC is configured for time domain duplexed (TDD) communications. To determine whether sounding reference signal (SRS) carrier switching (e.g., between the PCC and the SCC) is appropriate, the UE may monitor performance metrics. If the performance metrics fail to satisfy corresponding thresholds, the UE may reduce an SRS periodicity. For instance, the UE may request that a network entity reduce the SRS periodicity. Alternatively, the UE may reduce a quantity of antennas used for the SRS transmissions. In other examples, the UE may initiate an interchange between the PCC and the SCC such that SRS carrier switching is no longer utilized.

### FIELD OF TECHNOLOGY

The following relates to wireless communication, including improving user equipment (UE) performance in carrier aggregation (CA) scenarios.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support improving user equipment (UE) performance in carrier aggregation (CA) scenarios. For example, the described techniques provide for a UE to receive control signaling indicating a CA configuration that includes at least a primary component carrier (PCC) and a secondary component carrier (SCC), where the PCC is configured for frequency domain duplexed (FDD) communications and the SCC is configured for time domain duplexed (TDD) communications. The UE may monitor one or more performance metrics associated with communications at the UE and may determine whether performing sounding reference signal (SRS) carrier switching (e.g., between the PCC and the SCC) is appropriate. For example, if the UE detects, based on the monitoring, that a performance metric fails to satisfy a corresponding threshold, the UE may determine that SRS carrier switching may not improve channel estimation associated with SRS transmissions or that significant performance degradation may occur from SRS carrier switching.

In such cases, the UE may take action to reduce a periodicity with which SRSs are transmitted by the UE. For instance, the UE may transmit a UE assistance information (UAI) message to a network entity requesting that the network entity adjust (e.g., reduce) a configured SRS periodicity. Alternatively, the UE may adjust an antenna capability of the UE such that a quantity of antennas used for the SRS transmissions is reduced. Here, the UE may trigger a tracking area update (TAU) with the network entity to adjust the antenna capability. In other examples, the UE may initiate (e.g., at the UE or by triggering the network entity) an interchange between the PCC and the SCC such that SRS carrier switching is no longer utilized.

A method for wireless communication by a UE is described. The method may include receiving control signaling indicating a CA configuration for a set of component carriers, the set of component carriers including at least a primary carrier configured for FDD communications and a secondary carrier configured for TDD communications, monitoring one or more performance metrics associated with communications at the UE, transmitting a UE assistance information (UAI) message indicating a request to modify a configured periodicity of SRS transmissions by the UE via the secondary carrier based on detecting that a performance metric of the one or more performance metrics satisfying a threshold value, and communicating, via the secondary carrier, one or more SRS transmissions according to a periodicity that is updated based on transmitting the UAI message.

A UE for wireless communication is described. The UE may include one or more memories storing processor executable code, and one or more processors coupled with the one or more memories. The one or more processors may individually or collectively operable to execute the code to cause the UE to receive control signaling indicating a CA configuration for a set of component carriers, the set of component carriers including at least a primary carrier configured for FDD communications and a secondary carrier configured for TDD communications, monitor one or more performance metrics associated with communications at the UE, transmit a UAI message indicating a request to modify a configured periodicity of SRS transmissions by the UE via the secondary carrier based on detecting that a performance metric of the one or more performance metrics satisfying a threshold value, and communicating, via the secondary carrier, one or more SRS transmissions accord to a periodicity that is updated based on transmitting the UAI message.

Another UE for wireless communication is described. The UE may include means for receiving control signaling indicating a CA configuration for a set of component carriers, the set of component carriers including at least a primary carrier configured for FDD communications and a secondary carrier configured for TDD communications, means for monitoring one or more performance metrics associated with communications at the UE, means for transmitting a UAI message indicating a request to modify a configured periodicity of SRS transmissions by the UE via the secondary carrier based on detecting that a performance metric of the one or more performance metrics satisfying a threshold value, and means for communicating, via the secondary carrier, one or more SRS transmissions according to a periodicity that is updated based on transmitting the UAI message.

A non-transitory computer-readable medium storing code for wireless communication is described. The code may include instructions executable by at least one processor to receive control signaling indicating a CA configuration for a set of component carriers, the set of component carriers including at least a primary carrier configured for FDD communications and a secondary carrier configured for TDD communications, monitor one or more performance metrics associated with communications at the UE, transmit a UAI message indicating a request to modify a configured periodicity of SRS transmissions by the UE via the secondary carrier based on detecting that a performance metric of the one or more performance metrics satisfying a threshold value, and communicating, via the secondary carrier, one or more SRS transmissions accord to a periodicity that is updated based on transmitting the UAI message.

In some examples of the method, UEs, and non-transitory computer-readable medium described herein, monitoring the one or more performance metrics may include operations, features, means, or instructions for monitoring the one or more performance metrics in accordance with a monitoring periodicity that may be based on a coherence time associated with the UE.

Some examples of the method, UEs, and non-transitory computer-readable medium described herein may further include operations, features, means, or instructions for detecting, after updating the periodicity and based on the monitoring, that at least one performance metric of the one or more performance metrics fails to satisfy the threshold value and communicating, via the secondary carrier, a second one or more SRS transmissions according to the configured periodicity based on the at least one performance metric failing to satisfy the threshold value.

Some examples of the method, UEs, and non-transitory computer-readable medium described herein may further include operations, features, means, or instructions for detecting, after updating the periodicity and based on the monitoring. that at least one performance metric of the one or more performance metrics fails to satisfy the threshold value, transmitting a second UAI message indicating a second request to update the periodicity of the SRS transmissions by the UE via the secondary carrier based on the at least one performance metric failing to satisfy the threshold value, and communicating, via the secondary carrier, a second one or more SRS transmissions according to a second periodicity that may be updated based on transmitting the second UAI message.

In some examples of the method, UEs, and non-transitory computer-readable medium described herein, the second periodicity may be the same as the configured periodicity.

Some examples of the method, UEs, and non-transitory computer-readable medium described herein may further include operations, features, means, or instructions for receiving, in response to transmitting the UAI message, a control message indicating the periodicity and updating the configured periodicity to the periodicity based on receiving the control message.

In some examples of the method, UEs, and non-transitory computer-readable medium described herein, the one or more performance metrics include at least one of an uplink buffer size at the UE, a rate at which the uplink buffer size at the UE increases, a BLER associated with uplink communications at the UE, a path loss associated with the uplink communications at the UE, a downlink channel estimation obtained by the UE, a rank associated with downlink communications at the UE, a signal-to-noise ratio (SNR) associated with the UE, or a combination thereof and the threshold value includes at least one of a threshold uplink buffer size, a threshold rate at which the uplink buffer size at the UE increases, a threshold block error rate (BLER) associated with the uplink communications at the UE, a threshold path loss value associated with the uplink communications at the UE, a threshold downlink channel estimation value, a threshold rank value associated with the UE, a threshold SNR associated with the UE, or a combination thereof.

In some examples of the method, UEs, and non-transitory computer-readable medium described herein, the request to modify the configured periodicity includes an indication of the periodicity.

In some examples of the method, UEs, and non-transitory computer-readable medium described herein, the request to modify the configured periodicity includes a request to decrease the configured periodicity.

In some examples of the method, UEs, and non-transitory computer-readable medium described herein, the periodicity may be less than the configured periodicity.

A method for wireless communication by a UE is described. The method may include receiving control signaling indicating a CA configuration for a set of component carriers for the UE, the set of component carriers including at least a primary carrier configured for FDD communications and a secondary carrier configured for TDD communications, transmitting, while operating in a first tracking area according to a first antenna switching capability of the UE, a first message requesting to perform a tracking area update (TAU) procedure based on detecting that a performance metric associated with communications at the UE satisfies a threshold value, where the first antenna switching capability of the UE corresponds to a first quantity of receive antennas supported by the UE for communications via the secondary carrier, and where the first message indicates a tracking area identifier for the TAU procedure corresponding to the first tracking area, receiving, in response to the first message, a request for the UE to indicate a capability of the UE, transmitting, in response to the request, a second message indicating a second antenna switching capability of the UE based on adjusting the first antenna switching capability of the UE to the second antenna switching capability of the UE, the second antenna switching capability of the UE corresponding to a second quantity of receive antennas supported by the UE for communications via the secondary carrier, where the second quantity of receive antennas is less than the first quantity of receive antennas, and communicating, via the secondary carrier, one or more SRS transmissions in accordance with the second quantity of receive antennas.

A UE for wireless communication is described. The UE may include one or more memories storing processor executable code, and one or more processors coupled with the one or more memories. The one or more processors may individually or collectively operable to execute the code to cause the UE to receive control signaling indicating a CA configuration for a set of component carriers for the UE, the set of component carriers including at least a primary carrier configured for FDD communications and a secondary carrier configured for TDD communications, transmit, while operating in a first tracking area according to a first antenna switching capability of the UE, a first message requesting to perform a TAU procedure based on detecting that a performance metric associated with communications at the UE satisfies a threshold value, where the first antenna switching capability of the UE corresponds to a first quantity of receive antennas supported by the UE for communications via the secondary carrier, and where the first message indicates a tracking area identifier for the TAU procedure corresponding to the first tracking area, receive, in response to the first message, a request for the UE to indicate a capability of the UE, transmit, in response to the request, a second message indicating a second antenna switching capability of the UE based on adjusting the first antenna switching capability of the UE to the second antenna switching capability of the UE, the second antenna switching capability of the UE corresponding to a second quantity of receive antennas supported by the UE for communications via the secondary carrier, where the second quantity of receive antennas is less than the first quantity of receive antennas, and communicating, via the secondary carrier, one or more SRS transmissions in accordance with the second quantity of receive antennas.

Another UE for wireless communication is described. The UE may include means for receiving control signaling indicating a CA configuration for a set of component carriers for the UE, the set of component carriers including at least a primary carrier configured for FDD communications and a secondary carrier configured for TDD communications, means for transmitting, while operating in a first tracking area according to a first antenna switching capability of the UE, a first message requesting to perform a TAU procedure based on detecting that a performance metric associated with communications at the UE satisfies a threshold value, where the first antenna switching capability of the UE corresponds to a first quantity of receive antennas supported by the UE for communications via the secondary carrier, and where the first message indicates a tracking area identifier for the TAU procedure corresponding to the first tracking area, means for receiving, in response to the first message, a request for the UE to indicate a capability of the UE, means for transmitting. in response to the request, a second message indicating a second antenna switching capability of the UE based on adjusting the first antenna switching capability of the UE to the second antenna switching capability of the UE, the second antenna switching capability of the UE corresponding to a second quantity of receive antennas supported by the UE for communications via the secondary carrier, where the second quantity of receive antennas is less than the first quantity of receive antennas, and means for communicating, via the secondary carrier, one or more SRS transmissions in accordance with the second quantity of receive antennas.

A non-transitory computer-readable medium storing code for wireless communication is described. The code may include instructions executable by a processor to receive control signaling indicating a CA configuration for a set of component carriers for the UE, the set of component carriers including at least a primary carrier configured for FDD communications and a secondary carrier configured for TDD communications, transmit, while operating in a first tracking area according to a first antenna switching capability of the UE, a first message requesting to perform a TAU procedure based on detecting that a performance metric associated with communications at the UE satisfies a threshold value, where the first antenna switching capability of the UE corresponds to a first quantity of receive antennas supported by the UE for communications via the secondary carrier, and where the first message indicates a tracking area identifier for the TAU procedure corresponding to the first tracking area, receive, in response to the first message, a request for the UE to indicate a capability of the UE, transmit, in response to the request, a second message indicating a second antenna switching capability of the UE based on adjusting the first antenna switching capability of the UE to the second antenna switching capability of the UE, the second antenna switching capability of the UE corresponding to a second quantity of receive antennas supported by the UE for communications via the secondary carrier, where the second quantity of receive antennas is less than the first quantity of receive antennas, and communicating, via the secondary carrier, one or more SRS transmissions in accordance with the second quantity of receive antennas.

Some examples of the method, UEs, and non-transitory computer-readable medium described herein may further include operations, features, means, or instructions for monitoring one or more performance metrics including the performance metric to detect that the performance metric satisfies the threshold value, where the monitoring may be in accordance with a monitoring periodicity that may be based on a coherence time associated with the UE.

Some examples of the method, UEs, and non-transitory computer-readable medium described herein may further include operations, features, means, or instructions for detecting, after adjusting the first antenna switching capability of the UE to the second antenna switching capability of the UE and based on the monitoring, that at least one performance metric of the one or more performance metrics fails to satisfy the threshold value, adjusting the second antenna switching capability of the UE to the first antenna switching capability of the UE based on the at least one performance metric failing to satisfy the threshold value, and communicating, via the secondary carrier, a second one or more SRS transmissions in accordance with the first quantity of antennas.

In some examples of the method, UEs, and non-transitory computer-readable medium described herein, the performance metric includes at least one of an uplink buffer size at the UE, a rate at which the uplink buffer size at the UE increases, a BLER associated with uplink communications at the UE, a path loss associated with the uplink communications at the UE, a downlink channel estimation obtained by the UE, a rank associated with downlink communications at the UE, an SNR associated with the UE, or a combination thereof and the threshold value includes at least one of a threshold uplink buffer size, a threshold rate at which the uplink buffer size at the UE increases, a threshold BLER associated with the uplink communications at the UE, a threshold path loss value associated with the uplink communications at the UE, a threshold downlink channel estimation value, a threshold rank value associated with the UE, a threshold SNR ratio associated with the UE, or a combination thereof.

A method for wireless communication by a UE is described. The method may include receiving control signaling indicating a CA configuration for a set of component carriers, the set of component carriers including at least a first carrier configured as a primary cell and a second carrier configured as a secondary cell, where the first carrier is configured for FDD communications and the second carrier is configured for TDD communications, transmitting a measurement report based on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value, receiving control signaling triggering a handover procedure to switch the primary cell to be associated with the second carrier and the secondary cell to be associated with the first carrier based on the measurement report including the second value corresponding to the second signal strength measurement plus the offset value, and communicating one or more SRS transmissions via the second carrier based on performing the handover procedure.

A UE for wireless communication is described. The UE may include one or more memories storing processor executable code, and one or more processors coupled with the one or more memories. The one or more processors may individually or collectively operable to execute the code to cause the UE to receive control signaling indicating a CA configuration for a set of component carriers, the set of component carriers including at least a first carrier configured as a primary cell and a second carrier configured as a secondary cell, where the first carrier is configured for FDD communications and the second carrier is configured for TDD communications, transmit a measurement report based on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value, receive control signaling triggering a handover procedure to switch the primary cell to be associated with the second carrier and the secondary cell to be associated with the first carrier based on the measurement report including the second value corresponding to the second signal strength measurement plus the offset value, and communicate one or more SRS transmissions via the second carrier based on performing the handover procedure.

Another UE for wireless communication is described. The UE may include means for receiving control signaling indicating a CA configuration for a set of component carriers, the set of component carriers including at least a first carrier configured as a primary cell and a second carrier configured as a secondary cell, where the first carrier is configured for FDD communications and the second carrier is configured for TDD communications, means for transmitting a measurement report based on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value, means for receiving control signaling triggering a handover procedure to switch the primary cell to be associated with the second carrier and the secondary cell to be associated with the first carrier based on the measurement report including the second value corresponding to the second signal strength measurement plus the offset value, and means for communicating one or more SRS transmissions via the second carrier based on performing the handover procedure.

A non-transitory computer-readable medium storing code for wireless communication is described. The code may include instructions executable by At least one processor to receive control signaling indicating a CA configuration for a set of component carriers, the set of component carriers including at least a first carrier configured as a primary cell and a second carrier configured as a secondary cell, where the first carrier is configured for FDD communications and the second carrier is configured for TDD communications, transmit a measurement report based on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value, receive control signaling triggering a handover procedure to switch the primary cell to be associated with the second carrier and the secondary cell to be associated with the first carrier based on the measurement report including the second value corresponding to the second signal strength measurement plus the offset value, and communicate one or more SRS transmissions via the second carrier based on performing the handover procedure.

Some examples of the method, UEs, and non-transitory computer-readable medium described herein may further include operations, features, means, or instructions for monitoring one or more performance metrics including the performance metric to detect that the performance metric satisfies the first threshold value.

In some examples of the method, UEs, and non-transitory computer-readable medium described herein, the first signal strength measurement includes a first ratio of a received signal strength indicator (RSSI) for the primary cell to a reference signal received power (RSRP) for the primary cell, the second signal strength measurement includes a second ratio of an RSSI for the secondary cell to an RSRP for the secondary cell, and the difference value includes a difference between the first ratio and the second ratio.

In some examples of the method, UEs, and non-transitory computer-readable medium described herein, the second value may be greater than the first value.

In some examples of the method, UEs, and non-transitory computer-readable medium described herein, the first value includes the first signal strength measurement minus a second offset value.

In some examples of the method, UEs, and non-transitory computer-readable medium described herein, the performance metric includes at least one of an uplink buffer size at the UE, a rate at which the uplink buffer size at the UE increases, a BLER associated with uplink communications at the UE, a path loss associated with the uplink communications at the UE, a downlink channel estimation obtained by the UE, a rank associated with downlink communications at the UE, an SNR associated with the UE, or a combination thereof and the first threshold value includes at least one of a threshold uplink buffer size, a threshold rate at which the uplink buffer size at the UE increases, a threshold BLER associated with the uplink communications at the UE, a threshold path loss value associated with the uplink communications at the UE, a threshold downlink channel estimation value, a threshold rank value associated with the UE, a threshold SNR associated with the UE, or a combination thereof

### BRIEF DESCRIPTION OF THE DRAWINGS

FIGS. 1 and 2 show examples of wireless communications systems that support improving user equipment (UE) performance in carrier aggregation (CA) in accordance with one or more aspects of the present disclosure.

FIGS. 3 through 5 show examples of process flows that support improving UE performance in CA scenarios in accordance with one or more aspects of the present disclosure.

FIGS. 6 and 7 show block diagrams of devices that support improving UE performance in CA scenarios in accordance with one or more aspects of the present disclosure.

FIG. 8 shows a block diagram of a communications manager that supports improving UE performance in CA scenarios in accordance with one or more aspects of the present disclosure.

FIG. 9 shows a diagram of a system including a device that supports improving UE performance in CA scenarios in accordance with one or more aspects of the present disclosure.

FIGS. 10 through 13 show flowcharts illustrating methods that support improving UE performance in CA scenarios in accordance with one or more aspects of the present disclosure.

### DETAILED DESCRIPTION

Some wireless communications systems may employ sounding reference signals (SRSs) to improve channel estimation for communication between wireless devices. A user equipment (UE) may, for example, transmit one or more SRSs via an uplink channel to a network entity in communication with the UE. The network entity may perform measurements on the one or more SRSs to estimate conditions of the uplink channel. In scenarios where channel reciprocity is applicable, the network entity may assume that the estimated channel conditions for the uplink channel are substantively the same as channel conditions for a downlink channel with the UE. Thus, the network entity may obtain channel information (e.g., channel state information (CSI)) for the downlink channel by measuring the one or more SRSs. which may enable the network entity to achieve more accurate channel estimates for the downlink channel.

For example, in time domain duplexing (TDD) modes, a same frequency may be used for both uplink and downlink communications, such that the uplink channel and the downlink channel are substantively the same (e.g., are reciprocal). The network entity may use channel estimates from SRSs transmitted via the uplink channel to determine downlink channel estimates. Some UEs may be equipped with multiple receive (RX) antennas or antenna ports. To aid the network entity in obtaining a complete downlink channel estimate (e.g., for all possible downlink channels associated with the UE), the UE may transmit SRS from each of its RX antennas or antenna ports, which may be referred to as SRS antenna switching. Such techniques may be utilized in carrier aggregation (CA) scenarios, where the UE is configured with multiple component carriers (CCs) including at least a primary component carrier (PCC) and a secondary component carrier (SCC). In cases where the TDD is configured as an SCC. the UE may perform SRS carrier switching from the PCC to the SCC to transmit SRS. To enable the network entity to utilize reciprocity-based channel estimation for an SCC where the UE has different TX antennas than RX antennas, the UE may connect, by way of a switch, a transmit (TX) chain of the UE to an RX antenna to transmit SRS via the SCC using the RX antenna. The network entity may utilize the SRS to determine channel information for the SCC.

However, performing carrier switching may involve a duration of time during which the UE is unable to transmit uplink transmissions (e.g., because the TX chain of the UE is occupied by the SRS). In addition, the UE may tune a TX chain to the frequency of the SCC to transmit the SRS, and tune back to the frequency of the PCC, which also may take time to perform. Thus, improvements in channel estimation achieved by carrier switching techniques may be offset by degradation of uplink throughput and performance. The present disclosure therefore provides methods for reducing a frequency (e.g., occurrence rate) of SRS transmissions, such that the UE may perform SRS carrier switching when applicable without negatively impacting uplink throughput and performance. For example, in some conditions or scenarios, transmitting SRS may not provide a significant advantage to the UE or the network entity. More specifically, if the UE is rate-limited in the uplink or if downlink channel conditions are adequate and relatively static, any benefits provided by SRS carrier switching may not overcome the associated uplink performance degradation.

The UE may monitor one or more performance metrics associated with the uplink channel, the downlink channel, or both, to detect when (or if) the one or more performance metrics fail to satisfy a threshold. For instance, the UE may monitor an uplink channel performance metric including an uplink buffer size at the UE, a rate of increase of the uplink buffer size, an error rate (e.g., a block error rate (BLER)), or an uplink path loss parameter. If an uplink channel performance metric fails to satisfy a corresponding threshold, the UE may determine that the UE is uplink rate-limited and that SRS carrier switching may further degrade the uplink performance. Additionally, or alternatively, the UE may monitor a downlink channel performance metric, such as a downlink channel estimation parameter, a downlink channel rank, a downlink signal strength measurement (e.g., a signal-to-noise ratio (SNR)), or the like. If the downlink channel performance metric satisfies a corresponding threshold, the UE may determine that the downlink channel quality is sufficient and that SRS carrier switching is not necessary.

In either scenario, the UE may request that the network entity reduce a configured periodicity of SRS transmissions. Additionally, or alternatively, the UE may reduce (e.g., downgrade) an antenna capability (e.g., an antenna switching capability) of the UE, which may, in turn, reduce the periodicity of the SRS transmissions. Thus, the UE may continue to perform SRS transmissions to assist the network entity in downlink channel estimation, but may do so relatively less often so that the uplink performance degradation is lessened. In another embodiment, the UE may modify a measurement report transmitted to the network entity, which may trigger the network entity to switch the SCC and the PCC of the UE. Here, the SCC may be configured for TDD, such that when the SCC becomes the PCC (e.g., after the switch), the UE may transmit SRS via the newly-established PCC (e.g., without performing SRS carrier switching).

Aspects of the disclosure are initially described in the context of wireless communications systems. Aspects of the disclosure are then discussed with reference to process flows. Aspects of the disclosure are further illustrated by and described with reference to apparatus diagrams, system diagrams, and flowcharts that relate to improving UE performance in CA scenarios.

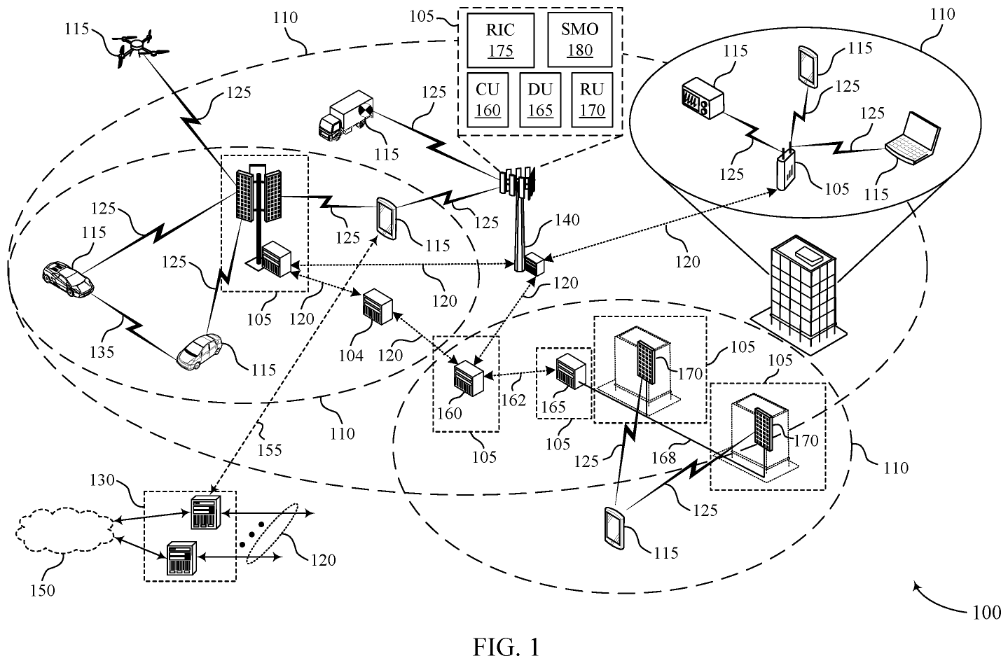

FIG. 1 shows an example of a wireless communications system 100 that supports improving UE performance in CA scenarios in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100. which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170. while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support indicating causes for life cycle management operations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A device in the wireless communications system 100, such as a UE 115, may be configured to provide SRS to another device, such as a network node or a network entity 105. The UE 115 may transmit one or more SRSs via a same (e.g., common or shared) resource (e.g., time resource, frequency resource, spatial resource) of an uplink channel as a downlink channel. The network entity 105 may use received SRS to determine downlink channel information (e.g., CSI) for a downlink channel (e.g., a physical downlink shared channel (PDSCH), a physical downlink control channel (PDCCH)) with the UE 115. For example, the network entity 105 may determine a channel quality indicator (CQI), rank indicator (RI), or precoding matrix indicator (PMI) based on measuring one or more received SRSs. Assuming channel reciprocity, the network entity 105 may schedule or allocate uplink and downlink resources (e.g., SRS resources) for the UE 115 based on the measured downlink channel information.

In some cases, the UE 115 may have multiple RX antenna ports, where each RX antenna port corresponds to a respective (e.g., different) communication channel (e.g., downlink channel). An antenna switching capability of the UE 115 may indicate a number of RX antenna ports of the UE 115. In some cases, SRS transmission, and the scheduling of SRS resource sets, for a particular UE 115 may further depend on the number of transmit (TX) chains of the UE 115 with antenna switching capabilities. For example, the RX antennas may outnumber the TX chains (and power amplifiers) in the UE 115. In such cases, one or more of the TX chains may be configured such that it may be selectively switched (“switchably coupled”) to multiple RX antennas. Thus, the UE 115 may switch a TX chain to an RX antenna or RX antenna port to transmit an SRS via a downlink carrier using the RX antenna or RX antenna port, which may be referred to as SRS transmit switching or SRS carrier switching. SRS carrier switching may enable the UE 115 to route SRS transmissions through all available antennas and antenna ports, which may enable the network entity 105 to obtain an accurate representation of all available channel conditions associated with the UE 115. Additionally, the network entity 105 may select appropriate communication parameters (e.g., beamforming weights) to optimize downlink capacity

Improved channel estimation may, in turn, improve downlink performance between the UE 115 and the network entity 105. For example, because the channel conditions for one RX antenna or RX antenna port may be different than the channel conditions for another RX antenna or RX antenna port, the UE 115 may be configured to perform SRS antenna switching to transmit SRS on each of its RX antenna ports. This may enable the network entity 105 to measure the respective channel conditions associated with each RX antenna or RX antenna port. Additionally, available uplink resources may be more limited than downlink resources. For example, the UE 115 may be equipped with fewer TX chains than RX antennas, may be configured with fewer uplink carriers than downlink carriers, or a given TDD carrier may be configured with more downlink resources than uplink resources. SRS carrier switching may enable the UE 115 to perform SRS transmission to improve CSI for downlink channels, and may be performed within downlink resources of a TDD carrier. The UE 115 may be able to achieve peak downlink capacity for a TDD carrier through the improved acquisition of CSI by the network entity 105, e.g., even without dedicated uplink SRS resources.

Since channel reciprocity is applicable only for TDD communications, SRS carrier switching may be utilized only when a channel or carrier via which the SRS is transmitted is configured for TDD communications. In some CA configurations, the UE 115 may be configured with a set of CCs including at least a PCC and an SCC. The PCC may, in turn, be configured as a primary cell (PCell) and may use FDD communications, while the SCC may be configured as a secondary cell (SCell) and may use TDD communications. Thus, the UE 115 may perform SRS carrier switching when the CA configuration includes a TDD-configured SCell and an FDD-configured PCell, as the channel reciprocity is only applicable for the SCell. For instance, the UE 115 may perform SRS carrier switching to switch the TX chain from the PCC to the SCC. The UE 115 may transmit SRS via the SCell to provide the network entity with channel information for the SCell.

SRS carrier switching may negatively impact uplink throughput and performance, however, as the UE 115 must switch the TX chain to an RX antenna port, perform radio frequency (RF) retuning to tune the TX chain to the SCC, transmit the SRS, switch the TX chain back to a TX antenna port, and retune the TX chain back to the PCC. During an SRS carrier switching procedure, as the TX chain of the UE 115 is occupied by the SRS transmission(s), the UE 115 may be unable to transmit uplink signals via an uplink carrier. The time duration, or time gap, during which the UE 115 switches (e.g., performs RF tuning) from one CC to another CC may be referred to as a switch time or switching time. For instance, higher layer parameters switchingTimeUL (e.g., an uplink switch time) and switchingTimeDL (e.g., a downlink switch time) may be defined for the UE 115, as well as a total switching time srs-Switching TimeNR. The UE 115 may indicate (e.g., via capability signaling), to the network entity 105, the switch time(s) (e.g., switchingTimeUL, switchingTimeDL, srs-SwitchingTimeNR) of which the UE 115 is capable. The switch time may be a time duration in microseconds (μs), such as a time duration between 0 us and 900 us, and the uplink throughput and performance may be degraded by a rate or amount that is proportional to the switch time of the UE 115.

Put another way, the SRS-SwitchingTimeNR generally indicates an interruption time on downlink transmission and uplink reception within a frequency band pair during RF retuning for switching between a carrier on one frequency band of the frequency band pair and another carrier on the other frequency band to transmit SRS. In some cases, the network entity 105 may allocate SRS resources to the UE 115 according to the switch time. As an example, the UE 115 may be tuned to a first carrier c0, but may be scheduled to perform an SRS transmission via a second carrier c1. The UE 115 may perform RF retuning to switch to the second carrier c1, transmit the SRS via the second carrier c1, and retune back to the first carrier c0 after the SRS transmission. The total switch time that it takes for the UE 115 to perform the SRS transmission and then be ready to perform communications (e.g., uplink or downlink communications) back on the first carrier c0 includes a switch time where the UE 115 retunes from c0 to c1, the time it takes for the UE 115 to perform the SRS transmission, and the switch time where the UE 115 retunes from c1 back to c0. Thus, the UE 115 may be unable to perform communications other than SRS transmissions during the switch time, thereby reducing throughput and degrading performance.

For example, the UE 115 may be configured to transmit SRS according to an SRS periodicity. In such examples, the UE 115 may perform SRS carrier switching (e.g., according to the switch time and the antenna switching capability of the UE 115) in accordance with the SRS periodicity to transmit the SRS. With each SRS carrier switch, the UE 115 may lose uplink transmission opportunities for at least the duration of the switch time. As a specific example, the SRS periodicity may be equal to 40 milliseconds (ms) and the UE 115 may have an antenna switching capability of four RX antenna ports and one TX antenna port, which may be represented as 1T4R. The UE 115 may transmit an SRS per each RX antenna port within the SRS periodicity, e.g., within the 40 ms. That is, every 10 ms, the UE 115 may transmit one SRS using one RX antenna port of the four RX antenna ports. The UE 115 may therefore lose at least seven time-domain symbols of uplink resources (e.g., may not be able to transmit uplink signals during at least seven time-domain symbols) for each SRS transmission. In other examples, the UE 115 may lose up to a full slot of uplink resources per SRS transmission.

The techniques described herein may enable the UE 115 to reduce an occurrence rate (e.g., periodicity or frequency) of SRS transmissions, which may, in turn, reduce degradation of uplink throughput and performance. For example, the UE 115 may monitor one or more uplink performance metrics, one or more downlink performance metrics, or a combination thereof, associated with communications at the UE 115. If conditions are appropriate (e.g., based on monitoring performance metrics), the UE 115 may request that the network entity 105 reduce a configured periodicity of SRS transmissions. The network entity 105 may provide the UE 115 with an updated SRS configuration that includes an updated (e.g., decreased) SRS periodicity. Additionally, or alternatively, the UE 115 may reduce (e.g., downgrade) an antenna capability (e.g., an antenna switching capability) of the UE 115, which may, in turn, reduce the periodicity of the SRS transmissions, as the UE 115 may have fewer antenna ports for which to transmit SRS. Thus, the UE 115 may continue to perform SRS transmissions to assist the network entity 105 in downlink channel estimation, but may do so relatively less often so that the impact to uplink performance and throughput is lessened. In another embodiment, the UE 115 may modify a measurement report transmitted to the network entity 105, which may trigger the network entity to switch the SCC and the PCC of the UE. After the switch, the UE 115 may transmit SRS via the SCC (e.g., configured to become the PCC), and may no longer need to perform SRS carrier switching.

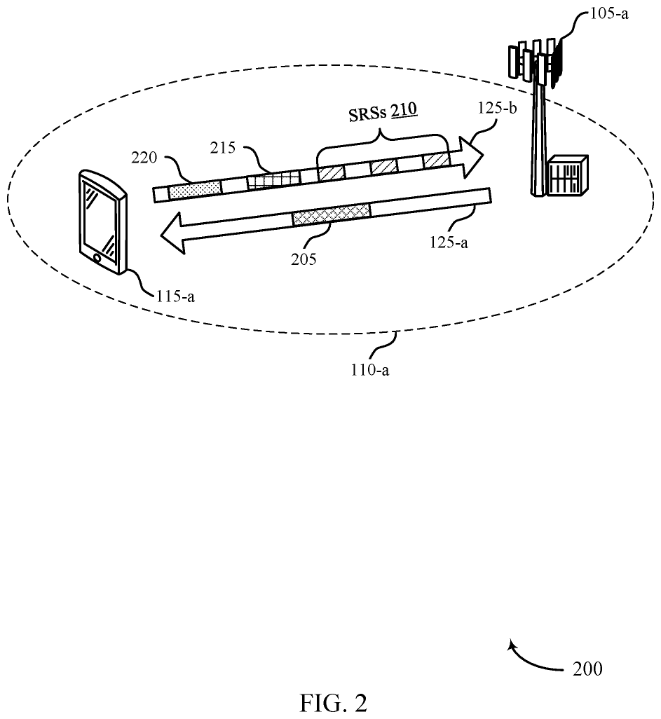

FIG. 2 shows an example of a wireless communications system 200 that supports improving UE performance in CA scenarios in accordance with one or more aspects of the present disclosure. In some examples, wireless communications system 200 may implement aspects of wireless communications system 100 and may include a UE 115-a and a network entity 105-a, which may be examples of corresponding devices as described with reference to FIG. 1. Although described as communications between the UE 115-a and the network entity 105-a, any type or quantity of devices may implement the techniques described herein. Further, the techniques described herein may be implemented by any type or quantity of devices of any wireless communications system.

The UE 115-a and the network entity 105-a may communicate, within a coverage area 110-a served by the network entity 105-a, via a communication link 125-a (e.g., a downlink communication link) and a communication link 125-b (e.g., an uplink communication link). The network entity 105-a may be a serving network entity for one or more serving cells associated with the UE 115-a, for example, in a CA configuration. The UE 115-a may be configured with the CA configuration including the one or more serving cells and a set of CCs. The set of CCs may include at least a PCC and an SCC, where the PCC is configured as a PCell for the UE 115-a, while the SCC may be configured as an SCell for the UE 115-a.

In the wireless communications system 200, the UE 115-a may transmit reference signals over a bandwidth of a communication link 125 to facilitate channel estimation and reporting of channel quality information. Reference signal transmissions may enable an estimation of the quality of a channel used to transmit data. In some cases, reference signals may be transmitted over a wide bandwidth. In other cases, reference signals may be transmitted on a partial radio frequency band. The timing (e.g., periodicity) of the reference signal transmissions and corresponding feedback reporting may be controlled by the network entity 105-a. For instance, the network entity 105-a may transmit, to the UE 115-a, a control message 205 (e.g., a radio resource control (RRC) message, a media access control (MAC) control element (MAC-CE), downlink control information (DCI), or the like) indicating an SRS configuration (e.g., SRS-Config) for the UE 115-a. In some examples, the control message 205 may additionally indicate the CA configuration.

The SRS configuration may include, but is not limited to, SRS resources (e.g., SRS-ResourceSet), an SRS periodicity (e.g., a periodicity according to which the UE 115-a is to transmit SRS, such as SRS-PeriodicityAndOffset), and an SRS usage type (e.g., antenna switching, codebook-based, non-codebook based, beam management, etc.), among other examples. The UE 115-a may transmit SRSs 210 to the network entity 105-a via the communication link 125-b and in accordance with the SRS configuration. The network entity 105-a may measure one or more channel state parameters of the SRSs 210 and may use the one or more channel state parameters to estimate a channel and perform link adaptation for subsequent communications with the UE 115-a. For instance, the network entity 105-a may adapt or otherwise control one or more communication parameters to improve channel quality based on estimating the channel.

The network entity 105-a may configure SRS resources that span one, two, or four adjacent symbols (e.g., within the last six symbols of a slot), with up to four ports per SRS resource. All ports of an SRS resource may be sounded in each configured symbol. An SRS resource may include a set of SRS resources transmitted by one UE (e.g., the UE 115-a), and may include downlink and uplink symbols that are not configured for physical uplink shared channel (PUSCH) or physical uplink control channel (PUCCH) transmission. An SRS resource may be transmitted aperiodically (e.g., triggered by the network entity 105-a, e.g., via DCI), semi-persistently, and/or periodically, e.g., according to the indicated SRS periodicity. In some cases, the UE 115-a may be configured with multiple SRS resources, which may be grouped into an SRS resource set depending on the use case (e.g., usage type). The SRS transmissions may be on a wideband or subband basis (e.g., the SRS transmission bandwidth may be a multiple of four physical resource blocks (PRBs)).

In the example of FIG. 2, the network entity 105-a may configure the UE 115-a to perform SRS carrier switching. SRS carrier switching may be activated or otherwise implemented when the UE 115-a is configured with a PCell/PCC that utilizes FDD communications and at least one SCell/SCC that utilizes TDD communications. That is, the network entity 105-a may perform channel estimation for a downlink channel based on receiving SRSs 210 only when channel reciprocity applies, e.g., only for TDD-configured channels. The UE 115-a may not transmit SRSs 210 via an FDD-configured channel, since the network entity 105-a would not be able to perform channel estimation based on channel reciprocity. Thus, the UE 115-a may perform SRS carrier switching to switch from the FDD-configured channel (e.g., the PCC) to the TDD-configured channel (e.g., the SCC) and may transmit SRSs 210 via the TDD-configured channel. In contrast, if the UE 115-a is configured with a PCell/PCC that utilizes TDD communications, the UE 115-a may not perform SRS carrier switching.

In such examples, the SRS usage type (e.g., the RRC parameter indicated in the SRS configuration of the control message 205, such as an RRC parameter SRS-ResourceSet.usage) may be set to SRS antenna switching (e.g., SRS-ResourceSet.usage=antennaSwitching), and the control message 205 (e.g., the SRS configuration) may indicate a higher layer (e.g., RRC) parameter carrierSwitching. The control message 205 (e.g., the SRS configuration) may further indicate a higher layer (e.g., RRC) parameter srs-SwitchFromServCellIndex, which may correspond to an index of a serving cell where the UE 115-a interrupts (e.g., suspends) transmission in order to transmit SRS on one or more other serving cells. Additionally, or alternatively, the control message 205 (e.g., the SRS configuration) may indicate a higher layer (e.g., RRC) parameter srs-SwitchFromCarrier, which may correspond to an uplink carrier (e.g., CC) where the UE interrupts transmission in order to transmit SRS on one or more other carriers (e.g., CCs).

Additionally, the SRS configuration may indicate one or more SRS ports, where each SRS port is mapped to a respective SRS resource grid. The quantity of SRS ports for the UE 115-a may depend on the quantity of uplink (e.g., TX) antennas of the UE 115-a. The UE 115-a may include a quantity x of TX antenna ports (e.g., uplink antenna ports) and a quantity y of RX antenna ports (e.g., downlink antenna ports), which may be referred to as an antenna capability of the UE 115-a (e.g., an antenna switching capability of the UE 115-a, such as supportedSRS-TxPortSwitch) and may be represented by xTyR. For example, an antenna capability of 1T2R indicates that the UE 115-a includes one TX antenna port and two RX antenna ports, an antenna capability of 2T4R indicates that the UE 115-a includes two TX antenna ports and four RX antenna ports, and so on. The antenna capability may also be understood as the UE 115-a's capability to transmit SRS on x antenna ports over a total of y antennas. The techniques described herein may be applicable to any configuration or combination of antennas, antenna ports, and antenna capabilities at the UE 115-a.

To perform SRS carrier switching, the UE 115-a may switch between CCs of the set of CCs by switching between antennas or antenna ports of the UE 115-a. The UE 115-a may transmit SRS via the SCC by switching a TX chain of the UE 115-a to an RX antenna of the UE 115-a and performing RF retuning. The UE 115-a may transmit SRS via each CC of the set of CCs according to an order of the CCs, an order of serving cells associated with the set of CCs, or the like. In some cases, the SRS configuration may indicate the order, or may indicate a cell index, carrier identifier, or the like, to or from which the UE 115-a is to perform the switching. After performing SRS carrier switching, the UE 115-a may switch the TX chain back to the TX antenna and may again perform RF retuning.

During SRS transmission on a first CC (e.g., a TDD CC) or a first cell (e.g., a downlink cell), such as the SCC or the SCell, the UE 115-a may temporarily suspend uplink transmission on a second CC (e.g., an uplink CC) or a second cell (e.g., an uplink cell), such as the PCC or the PCell. The UE 115-a may perform RF retuning to switch to the first CC and may transmit one or more SRSs 210 via the first CC. After SRS transmission, the UE 115-a may perform RF retuning to switch back to the second CC to perform other communications (e.g., uplink or downlink communications). A switch time of the UE 115-a may include the time duration during which the UE 115-a performs retuning to the first CC, transmits the one or more SRSs, and performs retuning back to the second CC. Other communications by the UE 115-a may be interrupted or otherwise delayed during the switch time.

Reducing the switch time of the UE 115-a may improve communications performance and throughput. However, the switch time of the UE 115-a may be defined by the UE 115-a's antenna architecture, such as the quantity of RX antenna ports and the quantity of TX antenna ports. The techniques described herein may enable the UE 115-a to indirectly reduce the switch time by reducing how often (e.g., a frequency with which) the UE 115-a transmits SRSs 210. For instance, the UE 115-a may adjust a quantity of antennas or antenna ports for which SRSs 210 are transmitted, may trigger the network entity 105-a to reconfigure the SRS periodicity to a reduced SRS periodicity, or may trigger a handover procedure to an appropriate CC/serving cell configuration.

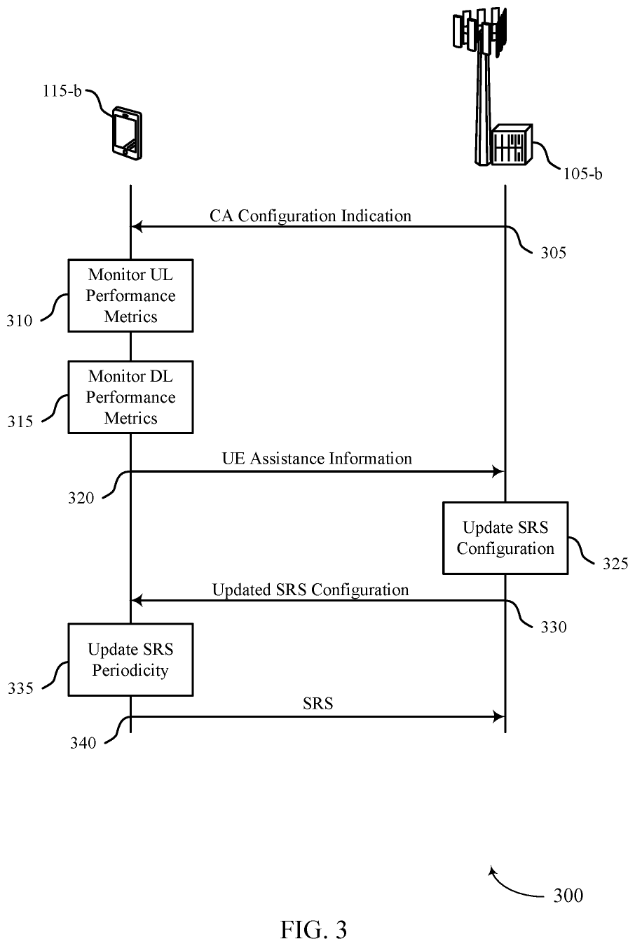

In a first example, and as described with reference to FIG. 3, the UE 115-a may transmit a UE assistance information (UAI) message 215 to the network entity 105-a to request that the network entity 105-a reconfigure the SRS periodicity, e.g., to an SRS periodicity that is less than (e.g., less frequent than) an initially-configured SRS periodicity, such as the SRS periodicity indicated in the control message 205. The UAI message 215 may indicate a request for a reduced SRS periodicity or may explicitly indicate a requested SRS periodicity. For example, the UAI message 215 may indicate a periodicity reduction request for the antenna switching SRS usage type (e.g., SRSUsageType=antennaSwitching).

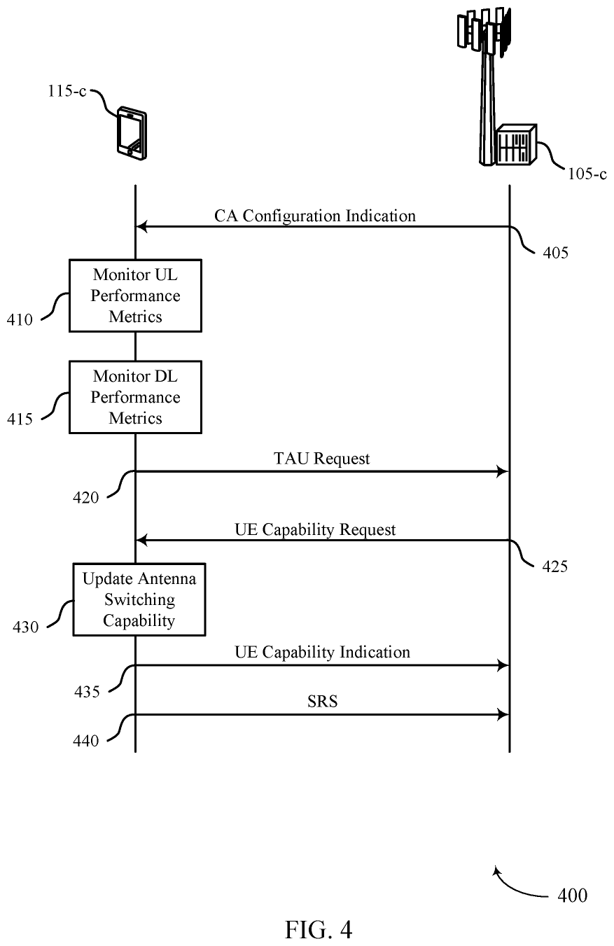

In another example, and as described with reference to FIG. 4, the UE 115-a may adjust (e.g., downgrade) an antenna capability of the UE 115-a. That is, although the UE 115-a may be equipped with a first quantity of TX antenna ports and a first quantity of RX antenna ports (e.g., equivalent to 1T4R), the UE 115-a may downgrade its antenna capability (e.g., to 1T2R) such that the UE 115-a utilizes a subset of the TX antenna ports (e.g., a second quantity of TX antenna ports that is less than the first quantity of TX antenna ports) and a subset of the RX antenna ports (e.g., a second quantity of RX antenna ports that is less than the first quantity of RX antenna ports). Here, the UE 115-a may reduce the switch time by reducing the quantity of antenna ports for which SRS switching is to be performed.

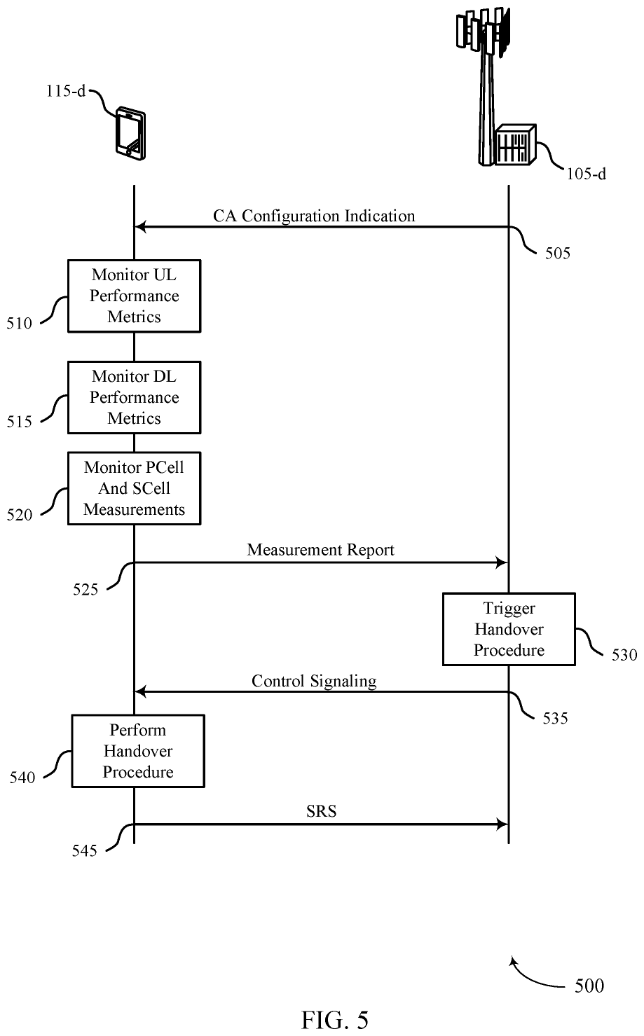

In yet another example, and as described with reference to FIG. 5, the UE 115-a may trigger a swap (e.g., handover or carrier switch) between the PCell and the SCell, such that the SCC becomes associated with the PCell and the PCC becomes associated with the SCell. This embodiment may be utilized when the UE 115-a is configured with an FDD PCell/PCC and a TDD SCell/SCC, as illustrated in FIG. 2. For example, the network entity 105-a may initially configure the UE 115-a with the FDD PCell/PCC. The network entity 105-a may subsequently transmit, to the UE 115-a, a reconfiguration message (e.g., an RRC reconfiguration message) indicating that the UE 115-a is to add a TDD-configured cell as an SCell/SCC. Since the UE 115-a may refrain from performing SRS carrier switching when the PCell/PCC utilizes TDD communications, the UE 115-a may trigger a handover procedure (e.g., carrier switch) to configure the SCell/SCC as the PCell/PCC and the PCell/PCC as the SCell/SCC. Thus, after the handover, the PCell/PCC may utilize TDD communications, and the UE 115-a may not perform SRS carrier switching to transmit the SRSs 210 to the network entity 105-a. Put another way, the UE 115-a may reduce the switch time to zero by triggering the handover and interchanging the PCell/PCC and the SCell/SCC.

The UE 115-a may trigger the handover based on one or more conditional handover (CHO) conditions, or one or more conditional PSCell change conditions, being met or otherwise satisfied. Alternatively, the UE 115-a may modify a measurement report 220 (e.g., an A5 measurement report) in such a manner that the network entity 105-a is triggered to initiate the handover. For instance, the UE 115-a may add an offset value to a signal quality value (such as a reference signal received power (RSRP) value) associated with the SCell/SCC, such that the SCell/SCC signal quality value included in the measurement report 220 is relatively better (e.g., stronger) than a signal quality value associated with the PCell/PCC included in the measurement report 220. Additionally, or alternatively, the UE 115-a may add a negative offset value to the signal quality value associated with the PCell/PCC. In any case, based on the measurement report 220, the network entity 105-a may initiate the handover to interchange the PCell/PCC and the SCell/SCC. After the handover, the UE 115-a may transmit the SRSs 210 via the new PCell/PCC.

In some cases, the network entity 105-a may instead initially configure the UE 115-a with a TDD PCell/PCC and an FDD SCell/SCC. In such cases, the UE 115-a may modify the measurement report 220 to prevent the network entity 105-a from performing a carrier switch and to maintain the TDD PCell/PCC and FDD SCell/SCC configuration. Here, the measurement report 220 may include or be an example of an A3 or A4 measurement report that the UE 115-a may modify to indicate that the TDD PCell/PCC is associated with a relatively better quality (e.g., signal quality) than the FDD SCell/SCC. In some examples, the UE 115-a may monitor a signal strength and signal quality (e.g., an RSRP and a reference signal strength indicator (RSSI)) of the TDD PCell/PCC and a signal strength and signal quality (e.g., RSRP and RSSI) of the FDD SCell/SCC to ensure that the TDD PCell/PCC is able to support sufficient performance and throughput. That is, the UE 115-a may monitor a difference in respective RSSI/RSRP values of the TDD PCell/PCC and the FDD SCell/SCC and may transmit the measurement report 220 provided the difference is below a threshold difference value.

The UE 115-a may reduce how often the SRSs 210 are transmitted based on one or more conditions or performance metrics. For example, transmitting periodic SRSs 210 may not improve channel estimation if the UE 115-a is relatively stationary (e.g., in low-mobility scenarios, as downlink conditions may be relatively constant), if the quality of the downlink channel is relatively good (e.g., if a signal-to-noise ratio (SNR) associated with the downlink channel is relatively high), or if a rank associated with the downlink channel is relatively low (e.g., is less than 4, which may indicate that the antennas are not well quasi co-located). In such examples, SRS carrier switching may not provide any advantage for the UE 115-a or the network entity 105-a. Additionally, or alternatively, if uplink throughput requirements are relatively high, or if the UE 115-a is rate-limited (e.g., constrained) in the uplink, the uplink throughput and performance degradation associated with SRS carrier switching may be sufficiently significant that such costs do not outweigh the corresponding channel estimation improvements.

Accordingly, the UE 115-a may monitor one or more conditions (e.g., uplink channel conditions, downlink channel conditions), one or more performance metrics (e.g., uplink performance metrics, downlink performance metrics, MAC layer performance metrics, physical layer (PHY) performance metrics) related to operations at the UE 115-a, or the like, to determine whether the SRS periodicity should be reduced. For example, when the UE 115-a is uplink rate-limited, a MAC layer uplink buffer of the UE 115-a may be relatively large or may increase in size relatively quickly, as the UE 115-a may not have sufficient uplink throughput or uplink resources available to consume all the data in the uplink buffer. The one or more performance metrics may therefore include a size of the uplink buffer, a rate at which the size of the uplink buffer increases, an amount by which the uplink buffer is overloaded, a quantity of packets discarded from the uplink buffer, or a combination thereof. During monitoring, the UE 115-a may compare (e.g., periodically) the one or more performance metrics to one or more corresponding threshold values. For instance, the one or more corresponding threshold values may include a threshold size of the uplink buffer, a threshold rate at which the size of the uplink buffer increases, a threshold amount by which the uplink buffer is overloaded, and a threshold quantity of packets discarded from the uplink buffer, respectively. The UE 115-a may be triggered to reduce the SRS periodicity (e.g., by transmitting the UAI message 215 or the measurement report 220, or by initiating the handover) if (e.g., when) at least one performance metric fails to satisfy the corresponding threshold value.

The one or more conditions may include or be an example of one or more performance metrics that are related to communications at the UE 115-a, such as a throughput requirement (e.g., a downlink throughput requirement, an uplink throughput requirement), an uplink block error rate (BLER), an uplink path loss value, a downlink channel estimation value or a change in downlink channel estimation values, an SNR associated with the UE 115-a, or a combination thereof, among other examples. The corresponding one or more threshold values may include a threshold throughput requirement (e.g., a threshold downlink throughput requirement, a threshold uplink throughput requirement), a threshold uplink BLER, a threshold uplink path loss value, a threshold downlink channel estimation value or a threshold change in downlink channel estimation values, and a threshold SNR associated with the UE 115-a, respectively. The UE 115-a may be triggered to reduce the SRS periodicity (e.g., by transmitting the UAI message 215 or the measurement report 220, or by initiating the handover) if (e.g., when) at least one condition (e.g., one communication performance metric) fails to satisfy the corresponding threshold value.

In some examples, the UE 115-a and the network entity 105-a may dynamically modify how often SRSs 210 are transmitted (e.g., may dynamically modify the SRS periodicity). For example, the UE 115-a may continue to monitor the one or more performance metrics for the uplink or the downlink over time, e.g., according to a monitoring periodicity. The monitoring periodicity may, for example, be configured as multiples of a coherence time of a corresponding channel. If the one or more performance metrics satisfy the corresponding one or more thresholds, the UE 115-a may transmit a second UAI message 215 to the network entity 105-a to request an increase in the SRS periodicity. For example, the second UAI message 215 may indicate an explicitly requested SRS periodicity that is greater than the previously-reduced SRS periodicity or may indicate a request to increase the SRS periodicity relative to a currently-configured SRS periodicity (e.g., the previously-reduced SRS periodicity). Alternatively, the UE 115-a may autonomously roll back the previously-reduced SRS periodicity to an initially-configured SRS periodicity (e.g., as indicated in the control message 205) or may transmit a modified measurement report 220 to trigger an increase in the SRS periodicity (e.g., from the network entity 105-a).

FIG. 3 shows an example of a process flow 300 that supports improving UE performance in CA scenarios in accordance with one or more aspects of the present disclosure. The process flow 300 may implement or be implemented to realize aspects of the wireless communications system 100 or the wireless communications system 200. For example, the process flow 300 illustrates communications between a UE 115-b and a network entity 105-b, which may be examples of corresponding devices as described herein. The UE 115-b and the network entity 105-b may communicate via one or more uplink channels (e.g., PUSCH, PUCCH) and one or more downlink channels (e.g., PDCCH, PDSCH).

In the process flow 300, the UE 115-b may operate according to a CA configuration that includes at least a PCC associated with a PCell and an SCC associated with an SCell. The PCC may be configured to operate according to an FDD mode and the SCC may be configured to operate according to a TDD mode. The UE 115-b may be capable of (e.g., configured to) perform SRS carrier switching based on an antenna switching capability of the UE 115-b. For example, the UE 115-b may switch from the PCC to the SCC to transmit SRS to the network entity 105-b via the SCC. After SRS transmission, the UE 115-b may switch back to the PCC.

In the following description of the process flow 300, the operations may be performed (e.g., reported or provided) in a different order than the order shown, or the operations performed by the example devices may be performed in different orders or at different times. Additionally, although the process flow 300 is described with reference to the UE 115-b and the network entity 105-b, any type of device or combination of devices may perform the described operations. Some operations also may be omitted from the process flow 300, or other operations may be added to the process flow 300. Further, although some operations or signaling may be shown to occur at different times for discussion purposes, these operations may actually occur at the same time or otherwise concurrently.

At 305, the network entity 105-a may transmit, and the UE 115-b may receive, control signaling (e.g., RRC, MAC-CE, DCI) indicating the CA configuration for a set of CCs including the PCC and the SCC. In some examples, the control signaling may additionally indicate an SRS configuration for SRSs to be transmitted by the UE 115-b. The SRS configuration may indicate a configured SRS periodicity for the SRSs.

At 310, the UE 115-b may monitor one or more uplink performance metrics associated with communications at the UE 115-b to determine whether the UE 115-b is uplink-constrained or uplink rate-limited. The one or more uplink performance metrics may be associated with one or more layers at the UE 115-b, such as a MAC layer or PHY layer. The UE 115-b may, for example, measure or otherwise track an uplink buffer size at the UE 115-b, a rate at which the uplink buffer size at the UE 115-b increases, a BLER associated with uplink communications at the UE 115-b, a path loss associated with the uplink communications at the UE 115-b, an uplink throughput requirement, or some combination thereof.

The UE 115-b may detect, based on the monitoring, whether each uplink performance metric of the one or more uplink performance metrics satisfies a corresponding threshold value. For example, the detecting may include the UE 115—comparing the uplink buffer size to a threshold uplink buffer size, comparing the rate at which the uplink buffer size at the UE 115-b increases to a threshold rate of increase, comparing the BLER associated with uplink communications at the UE 115-b with a threshold BLER, comparing the path loss associated with the uplink communications at the UE 115-b with a threshold path loss value, comparing the uplink throughput requirement with a threshold uplink throughput, or a combination thereof. Failure of an uplink performance metric to satisfy the corresponding threshold may be indicative of the UE 115-b being rate-limited in the uplink, which, in turn, may increase performance degradation associated with SRS carrier switching.

In some cases, the UE 115-b may monitor the one or more uplink performance metrics according to a coherence time associated with a channel (e.g., an uplink channel, a downlink channel) of the SCC. For instance, the UE 115-b may periodically monitor the one or more uplink performance metrics according to a monitoring periodicity that is a multiple of the coherence time.

At 315, the UE 115-b may monitor one or more downlink performance metrics associated with communications at the UE 115-b. The UE 115-b may, for example, measure or otherwise track one or more downlink channel estimation values (e.g., measured or obtained by the UE 115-b), a rank associated with downlink communications at the UE 115-b, an SNR associated with the UE 115-b, a downlink throughput requirement, or the like, among other examples.

The UE 115-b may detect, based on the monitoring, whether each downlink performance metric of the one or more downlink performance metrics satisfies a corresponding threshold value. For example, the detecting may include the UE 115—comparing the one or more downlink channel estimation values to one or more respective threshold downlink channel estimation values, comparing the rank to a threshold rank, comparing the SNR with the threshold SNR, comparing the downlink throughput requirement with a threshold downlink throughput, or some combination thereof. A downlink performance metric that satisfies a corresponding threshold may be indicative of relatively good channel conditions in the downlink, such that SRS carrier switching may not provide significant advantages.

In some cases, the UE 115-b may monitor the one or more downlink performance metrics according to the coherence time. For instance, the UE 115-b may periodically monitor the one or more downlink performance metrics according to a monitoring periodicity that is a multiple of the coherence time.

At 320, if the UE 115-b detects (e.g., at 310 or 315) that an uplink performance metric fails to satisfy a respective threshold value, the UE 115-b may transmit a UAI to the network entity 105-b. The determination may also be based on whether a downlink performance metric satisfies a respective threshold. For example, the UE 115-b may detect that an uplink performance metric fails to satisfy a first threshold, and may determine to transmit the UAI based on a downlink performance metric satisfying a second threshold. The UAI may include an indication of a request to modify a configured periodicity of SRS transmissions by the UE 115-b via the SCC. The configured periodicity may, for example, be a configured SRS periodicity indicated in the SRS configuration, and the UAI may indicate a request to change (e.g., update) the configured SRS periodicity to a second SRS periodicity, where the second SRS periodicity is less than the configured SRS periodicity. In some cases, the UAI may indicate, as part of the request, an indication of the second SRS periodicity. In other cases, the UAI may indicate a request to decrease the configured periodicity, for example, by an indicated amount.

At 325, in response to receiving the UAI indicating the request, the network entity 105-b may update or otherwise adjust the configured SRS periodicity in accordance with the request. Here, the network entity 105-b may change the configured SRS periodicity to the second SRS periodicity.

At 330, the network entity 105-b may transmit, and the UE 115-b may receive, in response to transmitting the UAI, a control message (e.g., RRC, MAC-CE, DCI) indicating the second SRS periodicity. For instance, the network entity 105-b may transmit the control message including an updated SRS configuration that includes the second SRS periodicity.

At 335, the UE 115-b may update the configured SRS periodicity to the second SRS periodicity based on receiving the control message at 330, based on transmitting the UAI at 320, or a combination thereof.

At 340, the UE 115-b may transmit, and the network entity 105-b may receive, via the SCC, one or more SRS transmissions according to the second periodicity.

In some cases, the UE 115-b and the network entity 105-b may repeat 310 through 340 periodically. For example, the UE 115-b may monitor the one or more uplink performance metrics, the one or more downlink performance metrics, or both, according to the monitoring periodicity. During subsequent monitoring (e.g., after updating the configured SRS periodicity to the second SRS periodicity), the UE 115-b may detect that an uplink performance metric or a downlink performance metric satisfies the corresponding threshold value. Based on the detection, in some cases, the UE 115-b may transmit a second UAI message indicating a second request to increase the SRS periodicity at the UE 115-b. For instance, the second UAI message may indicate a request to update the second SRS periodicity to a third SRS periodicity, where the third SRS periodicity may be greater than the second SRS periodicity. In some cases, the third SRS periodicity may be equal to the configured (e.g., initially-configured) SRS periodicity. The network entity 105-b may transmit an updated SRS configuration to the UE 115-b that indicates the third SRS periodicity. Additionally, or alternatively, the UE 115-b may autonomously increase the SRS periodicity based on the detecting. For instance, the UE 115-b may update the second SRS periodicity to the third SRS periodicity without transmitting the second UAI message. In any case, the UE 115-b may transmit, and the network entity 105-b may receive, one or more SRS transmissions according to the third SRS periodicity.

FIG. 4 shows an example of a process flow 400 that supports improving UE performance in CA scenarios in accordance with one or more aspects of the present disclosure. The process flow 400 may implement or be implemented to realize aspects of the wireless communications system 100 or the wireless communications system 200. For example, the process flow 400 illustrates communications between a UE 115-c and a network entity 105-c, which may be examples of corresponding devices as described herein. The UE 115-c and the network entity 105-c may communicate via one or more uplink channels (e.g., PUSCH, PUCCH) and one or more downlink channels (e.g., PDCCH, PDSCH). Additionally, the network entity 105-c and the UE 115-c may operate in a tracking area associated with a tracking area identifier (TAI).

In the process flow 400, the UE 115-c may operate according to a CA configuration that includes at least a PCC associated with a PCell and an SCC associated with an SCell. The PCC may be configured to operate according to an FDD mode and the SCC may be configured to operate according to a TDD mode. The UE 115-c may be capable of (e.g., configured to) perform SRS carrier switching based on a first antenna switching capability of the UE 115-c. For example, the UE 115-c may switch from the PCC to the SCC to transmit SRS to the network entity 105-c via the SCC. After SRS transmission, the UE 115-c may switch back to the PCC. The first antenna switching capability of the UE 115-c may correspond to a first quantity of receive antennas supported by the UE 115-c for communications via the SCC.

In the following description of the process flow 400, the operations may be performed (e.g., reported or provided) in a different order than the order shown, or the operations performed by the example devices may be performed in different orders or at different times. Additionally, although the process flow 400 is described with reference to the UE 115-c and the network entity 105-c, any type of device or combination of devices may perform the described operations. Some operations also may be omitted from the process flow 400, or other operations may be added to the process flow 400. Further, although some operations or signaling may be shown to occur at different times for discussion purposes, these operations may actually occur at the same time or otherwise concurrently.

At 405, the UE 115-c may operate according to the first antenna switching capability, which may include or be an example of a 1T4R antenna switching capability. The network entity 105-c may transmit, and the UE 115-c may receive, control signaling (e.g., RRC, MAC-CE, DCI) indicating the CA configuration for a set of CCs including the PCC and the SCC. In some examples, the control signaling may additionally indicate an SRS configuration for SRSs to be transmitted by the UE 115-c. The SRS configuration may indicate a configured SRS periodicity for the SRSs.

At 410, the UE 115-c may monitor one or more uplink performance metrics associated with communications at the UE 115-c to determine whether the UE 115-c is uplink-constrained or uplink rate-limited. The one or more uplink performance metrics may be associated with one or more layers at the UE 115-c, such as a MAC layer or PHY layer. The UE 115-c may, for example, measure or otherwise track an uplink buffer size at the UE 115-c, a rate at which the uplink buffer size at the UE 115-c increases, a BLER associated with uplink communications at the UE 115-c, a path loss associated with the uplink communications at the UE 115-c, an uplink throughput requirement, or some combination thereof.

The UE 115-c may detect, based on the monitoring, whether each uplink performance metric of the one or more uplink performance metrics satisfies a corresponding threshold value. For example, the detecting may include the UE 115—comparing the uplink buffer size to a threshold uplink buffer size, comparing the rate at which the uplink buffer size at the UE 115-c increases to a threshold rate of increase, comparing the BLER associated with uplink communications at the UE 115-c with a threshold BLER, comparing the path loss associated with the uplink communications at the UE 115-c with a threshold path loss value, comparing the uplink throughput requirement with a threshold uplink throughput, or a combination thereof. Failure of an uplink performance metric to satisfy the corresponding threshold may be indicative of the UE 115-c being rate-limited in the uplink, which, in turn, may increase performance degradation associated with SRS carrier switching.

In some cases, the UE 115-c may monitor the one or more uplink performance metrics according to a coherence time associated with a channel (e.g., an uplink channel, a downlink channel) of the SCC. For instance, the UE 115-c may periodically monitor the one or more uplink performance metrics according to a monitoring periodicity that is a multiple of the coherence time.

At 415, the UE 115-c may monitor one or more downlink performance metrics associated with communications at the UE 115-c. The UE 115-c may, for example, measure or otherwise track one or more downlink channel estimation values (e.g., measured or obtained by the UE 115-c), a rank associated with downlink communications at the UE 115-c, an SNR associated with the UE 115-c, a downlink throughput requirement, or the like, among other examples. The UE 115-c may detect, based on the monitoring, whether each downlink performance metric of the one or more downlink performance metrics satisfies a corresponding threshold value. For example, the detecting may include the UE 115—comparing the one or more downlink channel estimation values to one or more respective threshold downlink channel estimation values, comparing the rank to a threshold rank, comparing the SNR with the threshold SNR, comparing the downlink throughput requirement with a threshold downlink throughput, or some combination thereof. A downlink performance metric that satisfies a threshold may be indicative of relatively good channel conditions in the downlink, such that SRS carrier switching may not provide significant advantages.

In some cases, the UE 115-c may monitor the one or more downlink performance metrics according to the coherence time. For instance, the UE 115-c may periodically monitor the one or more downlink performance metrics according to a monitoring periodicity that is a multiple of the coherence time.

At 420, if the UE 115-c detects (e.g., at 410 or 415) that an uplink performance metric fails to satisfy a respective threshold value, the UE 115-c may trigger a tracking area update (TAU) procedure with the network entity 105-c. The trigger may also be based on whether a downlink performance metric satisfies a respective threshold. For example, the UE 115-b may detect that an uplink performance metric fails to satisfy a first threshold, and may determine to trigger the TAU procedure based on a downlink performance metric satisfying a second threshold. For instance, the UE 115-c may transmit, and the network entity 105-c may receive, a TAU request message (e.g., a ‘Force Radio Cap Update’ message) indicating a request to perform the TAU procedure. The TAU request message may include an indication of the TAI associated with the tracking area in which the UE 115-c and the network entity 105-c are located. Here, the TAU procedure may be utilized by the UE 115-c to update the antenna switching capability of the UE 115-c, e.g., to a second antenna switching capability different from the first antenna switching capability. That is, the UE 115-c may initiate the TAU procedure by transmitting the TAU request message while remaining in a same tracking area, e.g., without transitioning to a different tracking area from the network entity 105-c.

At 425, in response to receiving the TAU request message, the network entity 105-c may transmit, and the UE 115-c may receive, a UE capability request message (e.g., RRC, MAC-CE, DCI) indicating a request for the UE 115-c to indicate a capability of the UE 115-c. For instance, the network entity 105-c may transmit the UE capability request message indicating a request for the UE 115-c to indicate an antenna switching capability of the UE 115-c.

At 430, in response to receiving the UE capability request message, the UE 115-c may update the capability of the UE 115-c. For example, the UE 115-c may adjust the first antenna switching capability of the UE 115-c to a second antenna switching capability of the UE 115-c. The second antenna switching capability of the UE 115-c may correspond to a second quantity of receive antennas supported by the UE 115-c for communications via the SCC. The second quantity of receive antennas may be less than the first quantity of receive antennas. For example, the second antenna switching capability may be 1T2R.

At 435, the UE 115-c may transmit, and the network entity 105-c may receive, a UE capability indication including an indication of the second antenna switching capability of the UE 115-c, e.g., based on updating the antenna switching capability at 430.

At 440, the UE 115-c may transmit, and the network entity 105-c may receive, via the SCC, one or more SRS transmissions in accordance with the second quantity of receive antennas. For example, the UE 115-c may transmit a respective SRS transmission for each receive antenna or receive antenna port of the second quantity of receive antennas.

FIG. 5 shows an example of a process flow 500 that supports improving UE performance in CA scenarios in accordance with one or more aspects of the present disclosure. The process flow 500 may implement or be implemented to realize aspects of the wireless communications system 100 or the wireless communications system 200. For example, the process flow 500 illustrates communications between a UE 115-d and a network entity 105-d, which may be examples of corresponding devices as described herein. The UE 115-b and the network entity 105-b may communicate via one or more uplink channels (e.g., PUSCH, PUCCH) and one or more downlink channels (e.g., PDCCH, PDSCH).

In the process flow 500, the UE 115-d may operate according to a CA configuration that includes at least a PCC associated with a PCell and an SCC associated with an SCell. The PCC may be configured to operate according to an FDD mode and the SCC may be configured to operate according to a TDD mode. The UE 115-b may be capable of (e.g., configured to) perform SRS carrier switching based on an antenna switching capability of the UE 115-b. For example, the UE 115-b may switch from the PCC to the SCC to transmit SRS to the network entity 105-b via the SCC. After SRS transmission, the UE 115-b may switch back to the PCC.

In the following description of the process flow 500, the operations may be performed (e.g., reported or provided) in a different order than the order shown, or the operations performed by the example devices may be performed in different orders or at different times. Additionally, although the process flow 500 is described with reference to the UE 115-d and the network entity 105-d, any type of device or combination of devices may perform the described operations. Some operations also may be omitted from the process flow 500, or other operations may be added to the process flow 500. Further, although some operations or signaling may be shown to occur at different times for discussion purposes, these operations may actually occur at the same time or otherwise concurrently.

At 505, the network entity 105-d may transmit, and the UE 115-d may receive, control signaling (e.g., RRC, MAC-CE, DCI) indicating the CA configuration for a set of CCs including the PCC and the SCC. In some examples, the control signaling may additionally indicate an SRS configuration for SRSs to be transmitted by the UE 115-d. The SRS configuration may indicate a configured SRS periodicity for the SRSs.

At 510, the UE 115-d may monitor one or more uplink performance metrics associated with communications at the UE 115-d to determine whether the UE 115-d is uplink-constrained or uplink rate-limited. The one or more uplink performance metrics may be associated with one or more layers at the UE 115-d, such as a MAC layer or PHY layer. The UE 115-d may, for example, measure or otherwise track an uplink buffer size at the UE 115-d, a rate at which the uplink buffer size at the UE 115-d increases, a BLER associated with uplink communications at the UE 115-d, a path loss associated with the uplink communications at the UE 115-d, an uplink throughput requirement, or some combination thereof.

The UE 115-d may detect, based on the monitoring, whether each uplink performance metric of the one or more uplink performance metrics satisfies a corresponding threshold value. For example, the detecting may include the UE 115—domparing the uplink buffer size to a threshold uplink buffer size, comparing the rate at which the uplink buffer size at the UE 115-d increases to a threshold rate of increase, comparing the BLER associated with uplink communications at the UE 115-d with a threshold BLER, comparing the path loss associated with the uplink communications at the UE 115-d with a threshold path loss value, comparing the uplink throughput requirement with a threshold uplink throughput, or a combination thereof. Failure of an uplink performance metric to satisfy the corresponding threshold may be indicative of the UE 115-d being rate-limited in the uplink, which, in turn, may increase performance degradation associated with SRS carrier switching.

In some cases, the UE 115-d may monitor the one or more uplink performance metrics according to a coherence time associated with a channel (e.g., an uplink channel, a downlink channel) of the SCC. For instance, the UE 115-d may periodically monitor the one or more uplink performance metrics according to a monitoring periodicity that is a multiple of the coherence time.

At 515, the UE 115-d may monitor one or more downlink performance metrics associated with communications at the UE 115-d. The UE 115-d may, for example, measure or otherwise track one or more downlink channel estimation values (e.g., measured or obtained by the UE 115-d), a rank associated with downlink communications at the UE 115-d, an SNR associated with the UE 115-d, a downlink throughput requirement, or the like, among other examples.

The UE 115-d may detect, based on the monitoring, whether each downlink performance metric of the one or more downlink performance metrics satisfies a corresponding threshold value. For example, the detecting may include the UE 115—domparing the one or more downlink channel estimation values to one or more respective threshold downlink channel estimation values, comparing the rank to a threshold rank, comparing the SNR with the threshold SNR, comparing the downlink throughput requirement with a threshold downlink throughput, or some combination thereof. Failure of a downlink performance metric to satisfy a threshold may be indicative of relatively good channel conditions in the downlink, such that SRS carrier switching may not provide significant advantages.

In some cases, the UE 115-d may monitor the one or more downlink performance metrics according to the coherence time. For instance, the UE 115-d may periodically monitor the one or more downlink performance metrics according to a monitoring periodicity that is a multiple of the coherence time.

At 520, the UE 115-d may monitor (e.g., measure or track) a first set of signal strength measurements (e.g., RSRP, RSSI) associated with the PCell and a second set of signal strength measurements (e.g., RSRP, RSSI) associated with the SCell. The UE 115-d may determine a first signal strength measurement ratio (e.g., RSSI to RSRP) associated with the PCell and the first set of signal strength measurements, as well as a second signal strength measurement ratio (e.g., RSSI to RSRP) associated with the SCell and the second set of signal strength measurements. The UE 115-d may determine a difference value corresponding to a difference between the first signal strength measurement ratio and the second signal strength measurement ratio. The UE 115-d may compare the difference value to a threshold difference value to detect whether the difference value satisfies the threshold difference value.

At 525, the UE 115-d may determine (e.g., at 510, 515, or 520) whether an uplink performance metric, a downlink performance metric, the difference value, or a combination thereof, satisfies a respective threshold value. Based on the determination, the UE 115-d may transmit a measurement report (e.g., an A3 measurement report, an A4 measurement report, an A5 measurement report) to the network entity 105-d. For example, the UE 115-b may determine that an uplink performance metric fails to satisfy a first threshold, and may determine to transmit the measurement report based on a downlink performance metric satisfying a second threshold. In some examples, the UE 115-d may transmit the measurement report to trigger (e.g., initiate) a carrier switch (e.g., a handover) by the network entity 105-d between the PCC and the SCC.

The UE 115-d may adjust one or more signal strength measurements indicated in the measurement report such that the PCell (e.g., and PCC) is reported to be relatively better in quality than the SCell (e.g., and SCC) or that the PCell (e.g., and PCC) is reported to be relatively worse in quality than the SCell (e.g., and SCC). That is, the UE 115-d may not explicitly indicate the first and second sets of signal strength measurements monitored at 520; instead, the UE 115-d may indicate, within the measurement report, a first value corresponding to the first set of signal strength measurements and a second value corresponding to the second set of second signal strength measurements. The second value, which is associated with the SCC and SCell, may be greater than the first value, which is associated with the PCC and PCell. In some cases, the first value may be equal to the first set of signal strength measurements minus a first offset value. For example, the first value may correspond to an RSRP measurement for the PCell (e.g., the PCC) and may be equal to the measured RSRP of the PCell (e.g., P_{RSRP}) minus the first offset value (e.g., Δ₁). Additionally, or alternatively, the second value may be equal to the second set of signal strength measurements for the SCell (e.g., S_{RSRP}) plus a second offset value (e.g., Δ₂).

At 530, based on receiving the measurement report indicating that the SCell is relatively better in quality than the PCell (e.g., based on the measurement report indicating that the second value is greater than the first value), the network entity 105-d may trigger a handover procedure to interchange the PCell and the SCell.

At 535, the network entity 105-d may transmit, and the UE 115-d may receive, control signaling initiating the handover procedure at the UE 115-d.

At 540, the UE 115-d may initiate the handover procedure to interchange the PCell and the SCell. Specifically, the handover procedure may switch the PCell to be associated with the SCC (e.g., the PCC becomes the SCC and the PCell becomes the SCell) and switch the SCell to be associated with the PCC (e.g., the SCC becomes the PCC and the SCell becomes the PCell).

At 545, the UE 115-d may transmit, and the network entity 105-d may receive, one or more SRSs via the SCC (e.g., the former PCC) after performing the handover procedure. Additionally, after performing the handover procedure, the UE 115-d may refrain from performing SRS carrier switching.

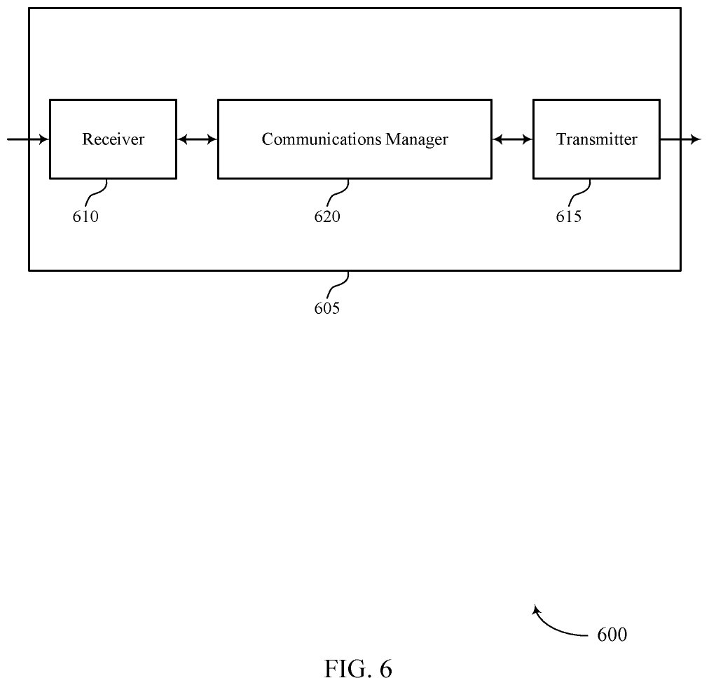

FIG. 6 shows a block diagram 600 of a device 605 that supports improving UE performance in CA scenarios in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to improving UE performance in CA scenarios). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to improving UE performance in CA scenarios). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of improving UE performance in CA scenarios as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving control signaling indicating a CA configuration for a set of CCs, the set of CCs including at least a primary carrier configured for FDD communications and a secondary carrier configured for TDD communications. The communications manager 620 is capable of, configured to, or operable to support a means for monitoring one or more performance metrics associated with communications at the UE. The communications manager 620 is capable of, configured to, or operable to support a means for transmitting a UAI message indicating a request to modify a configured periodicity of SRS transmissions by the UE via the secondary carrier based on detecting that a performance metric of the one or more performance metrics satisfying a threshold value. The communications manager 620 is capable of, configured to, or operable to support a means for communicating, via the secondary carrier, one or more SRS transmissions according to a periodicity that is updated based on transmitting the UAI message.

Additionally, or alternatively, the communications manager 620 may support wireless communication in accordance with examples as disclosed herein. For example, the communications manager 620 is capable of, configured to, or operable to support a means for receiving control signaling indicating a CA configuration for a set of CCs for the UE, the set of CCs including at least a primary carrier configured for FDD communications and a secondary carrier configured for TDD communications. The communications manager 620 is capable of, configured to, or operable to support a means for transmitting, while operating in a first tracking area according to a first antenna switching capability of the UE, a first message requesting to perform a TAU procedure based on detecting that a performance metric associated with communications at the UE satisfies a threshold value, where the first antenna switching capability of the UE corresponds to a first quantity of receive antennas supported by the UE for communications via the secondary carrier, and where the first message indicates a TAI for the TAU procedure corresponding to the first tracking area. The communications manager 620 is capable of, configured to, or operable to support a means for receiving, in response to the first message, a request for the UE to indicate a capability of the UE. The communications manager 620 is capable of, configured to, or operable to support a means for transmitting, in response to the request, a second message indicating a second antenna switching capability of the UE based on adjusting the first antenna switching capability of the UE to the second antenna switching capability of the UE, the second antenna switching capability of the UE corresponding to a second quantity of receive antennas supported by the UE for communications via the secondary carrier, where the second quantity of receive antennas is less than the first quantity of receive antennas. The communications manager 620 is capable of, configured to, or operable to support a means for communicating, via the secondary carrier, one or more SRS transmissions in accordance with the second quantity of receive antennas.

Additionally, or alternatively, the communications manager 620 may support wireless communication in accordance with examples as disclosed herein. For example, the communications manager 620 is capable of, configured to, or operable to support a means for receiving control signaling indicating a CA configuration for a set of CCs, the set of CCs including at least a first carrier configured as a primary cell and a second carrier configured as a secondary cell, where the first carrier is configured for FDD communications and the second carrier is configured for TDD communications. The communications manager 620 is capable of, configured to, or operable to support a means for transmitting a measurement report based on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value. The communications manager 620 is capable of, configured to, or operable to support a means for receiving control signaling triggering a handover procedure to switch the primary cell to be associated with the second carrier and the secondary cell to be associated with the first carrier based on the measurement report including the second value corresponding to the second signal strength measurement plus the offset value. The communications manager 620 is capable of, configured to, or operable to support a means for communicating one or more SRS transmissions via the second carrier based on performing the handover procedure.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for improving channel estimation accuracy while avoiding performance degradation. The device 605 may reduce SRS transmission periodicity based on monitoring one or more performance metrics or conditions, thereby reducing how often SRS carrier switching is performed by the device 605. Performing SRS carrier switching less often may correspond to reduced processing and power consumption at the device 605 by enabling the device 605 to avoid frequent RF retuning.

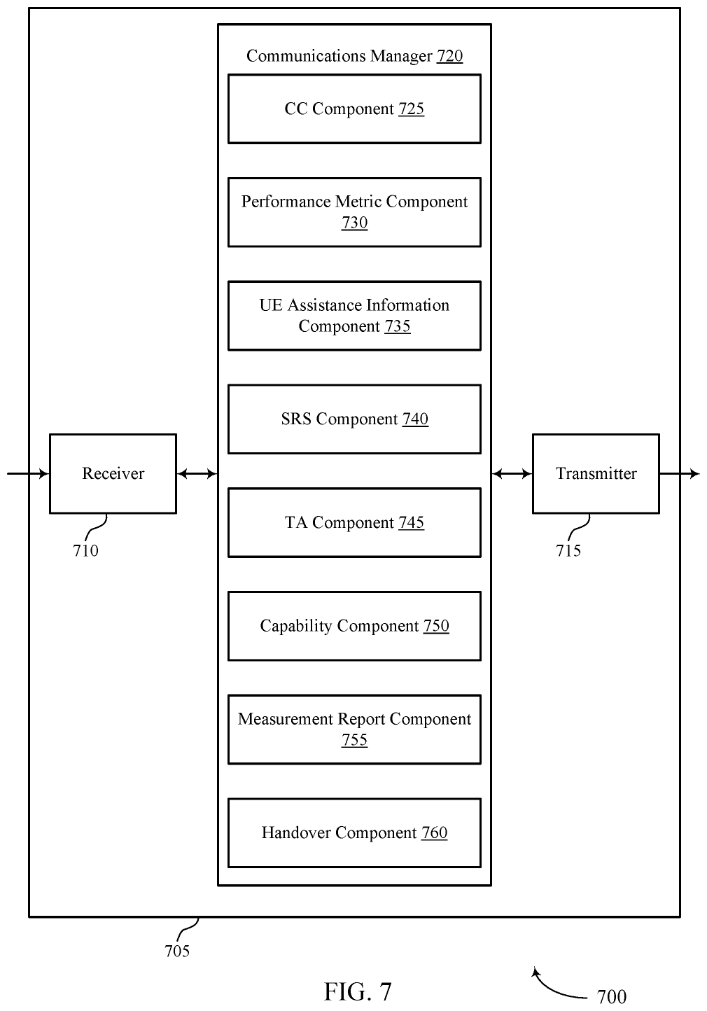

FIG. 7 shows a block diagram 700 of a device 705 that supports improving UE performance in CA scenarios in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to improving UE performance in CA scenarios). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to improving UE performance in CA scenarios). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of improving UE performance in CA scenarios as described herein. For example, the communications manager 720 may include a CC component 725, a performance metric component 730, a UAI component 735, an SRS component 740, a TA component 745, a capability component 750, a measurement report component 755, a handover component 760, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The CC component 725 is capable of, configured to, or operable to support a means for receiving control signaling indicating a CA configuration for a set of CCs, the set of CCs including at least a primary carrier configured for FDD communications and a secondary carrier configured for TDD communications. The performance metric component 730 is capable of, configured to, or operable to support a means for monitoring one or more performance metrics associated with communications at the UE. The UAI component 735 is capable of, configured to, or operable to support a means for transmitting a UAI message indicating a request to modify a configured periodicity of SRS transmissions by the UE via the secondary carrier based on detecting that a performance metric of the one or more performance metrics satisfying a threshold value. The SRS component 740 is capable of, configured to, or operable to support a means for communicating, via the secondary carrier, one or more SRS transmissions according to a periodicity that is updated based on transmitting the UAI message.

Additionally, or alternatively, the communications manager 720 may support wireless communication in accordance with examples as disclosed herein. The CC component 725 is capable of, configured to, or operable to support a means for receiving control signaling indicating a CA configuration for a set of CCs for the UE, the set of CCs including at least a primary carrier configured for FDD communications and a secondary carrier configured for TDD communications. The TA component 745 is capable of, configured to, or operable to support a means for transmitting, while operating in a first tracking area according to a first antenna switching capability of the UE, a first message requesting to perform a TAU procedure based on detecting that a performance metric associated with communications at the UE satisfies a threshold value, where the first antenna switching capability of the UE corresponds to a first quantity of receive antennas supported by the UE for communications via the secondary carrier, and where the first message indicates a TAI for the TAU procedure corresponding to the first tracking area. The capability component 750 is capable of, configured to, or operable to support a means for receiving, in response to the first message, a request for the UE to indicate a capability of the UE. The capability component 750 is capable of, configured to, or operable to support a means for transmitting, in response to the request, a second message indicating a second antenna switching capability of the UE based on adjusting the first antenna switching capability of the UE to the second antenna switching capability of the UE, the second antenna switching capability of the UE corresponding to a second quantity of receive antennas supported by the UE for communications via the secondary carrier, where the second quantity of receive antennas is less than the first quantity of receive antennas. The SRS component 740 is capable of, configured to, or operable to support a means for communicating, via the secondary carrier, one or more SRS transmissions in accordance with the second quantity of receive antennas.

Additionally, or alternatively, the communications manager 720 may support wireless communication in accordance with examples as disclosed herein. The CC component 725 is capable of, configured to, or operable to support a means for receiving control signaling indicating a CA configuration for a set of CCs, the set of CCs including at least a first carrier configured as a primary cell and a second carrier configured as a secondary cell, where the first carrier is configured for FDD communications and the second carrier is configured for TDD communications. The measurement report component 755 is capable of, configured to, or operable to support a means for transmitting a measurement report based on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value. The handover component 760 is capable of, configured to, or operable to support a means for receiving control signaling triggering a handover procedure to switch the primary cell to be associated with the second carrier and the secondary cell to be associated with the first carrier based on the measurement report including the second value corresponding to the second signal strength measurement plus the offset value. The SRS component 740 is capable of, configured to, or operable to support a means for communicating one or more SRS transmissions via the second carrier based on performing the handover procedure.

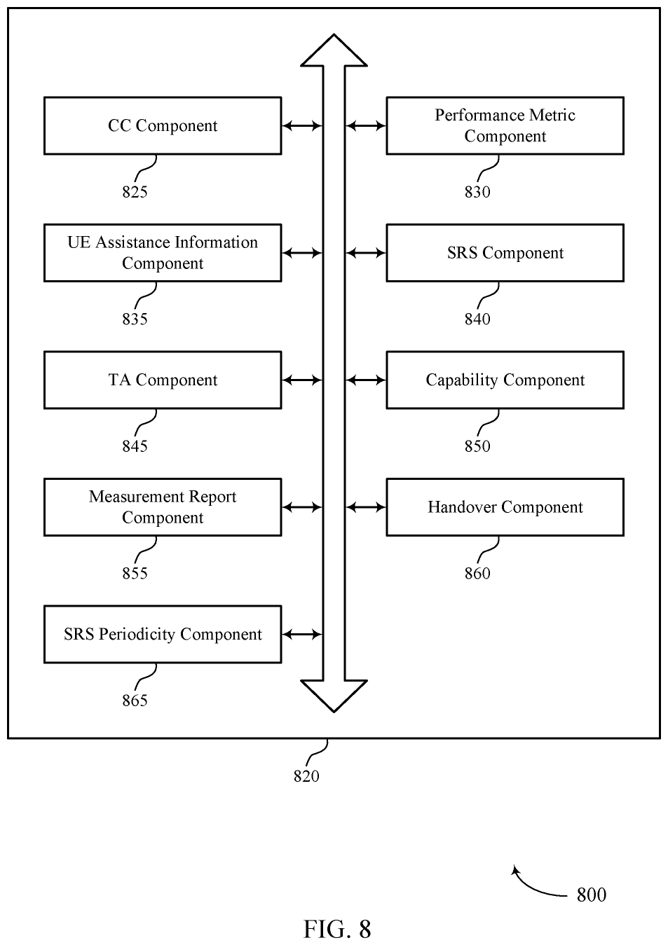

FIG. 8 shows a block diagram 800 of a communications manager 820 that supports improving UE performance in CA scenarios in accordance with one or more aspects of the present disclosure. The communications manager 820 may be an example of aspects of a communications manager 620, a communications manager 720, or both, as described herein. The communications manager 820, or various components thereof, may be an example of means for performing various aspects of improving UE performance in CA scenarios as described herein. For example, the communications manager 820 may include a CC component 825, a performance metric component 830, a UAI component 835, an SRS component 840, a TA component 845, a capability component 850, a measurement report component 855, a handover component 860, an SRS periodicity component 865, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The CC component 825 is capable of, configured to, or operable to support a means for receiving control signaling indicating a CA configuration for a set of CCs, the set of CCs including at least a primary carrier configured for FDD communications and a secondary carrier configured for TDD communications. The performance metric component 830 is capable of, configured to, or operable to support a means for monitoring one or more performance metrics associated with communications at the UE. The UAI component 835 is capable of, configured to, or operable to support a means for transmitting a UAI message indicating a request to modify a configured periodicity of SRS transmissions by the UE via the secondary carrier based on detecting that a performance metric of the one or more performance metrics satisfying a threshold value. The SRS component 840 is capable of, configured to, or operable to support a means for communicating, via the secondary carrier, one or more SRS transmissions according to a periodicity that is updated based on transmitting the UAI message.

In some examples, to support monitoring the one or more performance metrics, the performance metric component 830 is capable of, configured to, or operable to support a means for monitoring the one or more performance metrics in accordance with a monitoring periodicity that is based on a coherence time associated with the UE.

In some examples, the performance metric component 830 is capable of, configured to, or operable to support a means for detecting, after updating the periodicity and based on the monitoring, that at least one performance metric of the one or more performance metrics fails to satisfy the threshold value. In some examples, the SRS component 840 is capable of, configured to, or operable to support a means for communicating, via the secondary carrier, a second one or more SRS transmissions according to the configured periodicity based on the at least one performance metric failing to satisfy the threshold value.

In some examples, the performance metric component 830 is capable of, configured to, or operable to support a means for detecting, after updating the periodicity and based on the monitoring, that at least one performance metric of the one or more performance metrics fails to satisfy the threshold value. In some examples, the UAI component 835 is capable of, configured to, or operable to support a means for transmitting a second UAI message indicating a second request to update the periodicity of the SRS transmissions by the UE via the secondary carrier based on the at least one performance metric failing to satisfy the threshold value. In some examples, the SRS component 840 is capable of, configured to, or operable to support a means for communicating, via the secondary carrier, a second one or more SRS transmissions according to a second periodicity that is updated based on transmitting the second UAI message. In some examples, the second periodicity is the same as the configured periodicity.

In some examples, the SRS periodicity component 865 is capable of, configured to, or operable to support a means for receiving, in response to transmitting the UAI message, a control message indicating the periodicity. In some examples, the SRS periodicity component 865 is capable of, configured to, or operable to support a means for updating the configured periodicity to the periodicity based on receiving the control message.

In some examples, the one or more performance metrics include at least one of an uplink buffer size at the UE, a rate at which the uplink buffer size at the UE increases, a BLER associated with uplink communications at the UE, a path loss associated with the uplink communications at the UE, a downlink channel estimation obtained by the UE, a rank associated with downlink communications at the UE, a SNR ratio associated with the UE, or a combination thereof. In some examples, the threshold value includes at least one of a threshold uplink buffer size, a threshold rate at which the uplink buffer size at the UE increases, a threshold BLER associated with the uplink communications at the UE, a threshold path loss value associated with the uplink communications at the UE, a threshold downlink channel estimation value, a threshold rank value associated with the UE, a threshold SNR ratio associated with the UE, or a combination thereof.

In some examples, the request to modify the configured periodicity includes an indication of the periodicity. In some examples, the request to modify the configured periodicity includes a request to decrease the configured periodicity. In some examples, the periodicity is less than the configured periodicity.

Additionally, or alternatively, the communications manager 820 may support wireless communication in accordance with examples as disclosed herein. In some examples, the CC component 825 is capable of, configured to, or operable to support a means for receiving control signaling indicating a CA configuration for a set of CCs for the UE, the set of CCs including at least a primary carrier configured for FDD communications and a secondary carrier configured for TDD communications. The TA component 845 is capable of, configured to, or operable to support a means for transmitting, while operating in a first tracking area according to a first antenna switching capability of the UE, a first message requesting to perform a TAU procedure based on detecting that a performance metric associated with communications at the UE satisfies a threshold value, where the first antenna switching capability of the UE corresponds to a first quantity of receive antennas supported by the UE for communications via the secondary carrier, and where the first message indicates a TAI for the TAU procedure corresponding to the first tracking area. The capability component 850 is capable of, configured to, or operable to support a means for receiving, in response to the first message, a request for the UE to indicate a capability of the UE. In some examples, the capability component 850 is capable of, configured to, or operable to support a means for transmitting, in response to the request, a second message indicating a second antenna switching capability of the UE based on adjusting the first antenna switching capability of the UE to the second antenna switching capability of the UE, the second antenna switching capability of the UE corresponding to a second quantity of receive antennas supported by the UE for communications via the secondary carrier, where the second quantity of receive antennas is less than the first quantity of receive antennas. In some examples, the SRS component 840 is capable of, configured to, or operable to support a means for communicating, via the secondary carrier, one or more SRS transmissions in accordance with the second quantity of receive antennas.

In some examples, the performance metric component 830 is capable of, configured to, or operable to support a means for monitoring one or more performance metrics including the performance metric to detect that the performance metric satisfies the threshold value, where the monitoring is in accordance with a monitoring periodicity that is based on a coherence time associated with the UE.

In some examples, the performance metric component 830 is capable of, configured to, or operable to support a means for detecting, after adjusting the first antenna switching capability of the UE to the second antenna switching capability of the UE and based on the monitoring, that at least one performance metric of the one or more performance metrics fails to satisfy the threshold value. In some examples, the capability component 850 is capable of, configured to, or operable to support a means for adjusting the second antenna switching capability of the UE to the first antenna switching capability of the UE based on the at least one performance metric failing to satisfy the threshold value. In some examples, the SRS component 840 is capable of, configured to, or operable to support a means for communicating, via the secondary carrier, a second one or more SRS transmissions in accordance with the first quantity of antennas.

In some examples, the performance metric includes at least one of an uplink buffer size at the UE, a rate at which the uplink buffer size at the UE increases, a BLER associated with uplink communications at the UE, a path loss associated with the uplink communications at the UE, a downlink channel estimation obtained by the UE, a rank associated with downlink communications at the UE, a SNR ratio associated with the UE, or a combination thereof. In some examples, the threshold value includes at least one of a threshold uplink buffer size, a threshold rate at which the uplink buffer size at the UE increases, a threshold BLER associated with the uplink communications at the UE, a threshold path loss value associated with the uplink communications at the UE, a threshold downlink channel estimation value, a threshold rank value associated with the UE, a threshold SNR ratio associated with the UE, or a combination thereof.

Additionally, or alternatively, the communications manager 820 may support wireless communication in accordance with examples as disclosed herein. In some examples, the CC component 825 is capable of, configured to, or operable to support a means for receiving control signaling indicating a CA configuration for a set of CCs, the set of CCs including at least a first carrier configured as a primary cell and a second carrier configured as a secondary cell, where the first carrier is configured for FDD communications and the second carrier is configured for TDD communications. The measurement report component 855 is capable of, configured to, or operable to support a means for transmitting a measurement report based on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value. The handover component 860 is capable of, configured to, or operable to support a means for receiving control signaling triggering a handover procedure to switch the primary cell to be associated with the second carrier and the secondary cell to be associated with the first carrier based on the measurement report including the second value corresponding to the second signal strength measurement plus the offset value. In some examples, the SRS component 840 is capable of, configured to, or operable to support a means for communicating one or more SRS transmissions via the second carrier based on performing the handover procedure.

In some examples, the performance metric component 830 is capable of, configured to, or operable to support a means for monitoring one or more performance metrics including the performance metric to detect that the performance metric satisfies the first threshold value.

In some examples, the first signal strength measurement includes a first ratio of an RSSI for the primary cell to an RSRP for the primary cell. In some examples, the second signal strength measurement includes a second ratio of an RSSI for the secondary cell to an RSRP for the secondary cell. In some examples, the difference value includes a difference between the first ratio and the second ratio. In some examples, the second value is greater than the first value. In some examples, the first value includes the first signal strength measurement minus a second offset value.

In some examples, the performance metric includes at least one of an uplink buffer size at the UE, a rate at which the uplink buffer size at the UE increases, a BLER associated with uplink communications at the UE, a path loss associated with the uplink communications at the UE, a downlink channel estimation obtained by the UE, a rank associated with downlink communications at the UE, a SNR ratio associated with the UE, or a combination thereof. In some examples, the first threshold value includes at least one of a threshold uplink buffer size, a threshold rate at which the uplink buffer size at the UE increases, a threshold BLER associated with the uplink communications at the UE, a threshold path loss value associated with the uplink communications at the UE, a threshold downlink channel estimation value, a threshold rank value associated with the UE, a threshold SNR ratio associated with the UE, or a combination thereof.

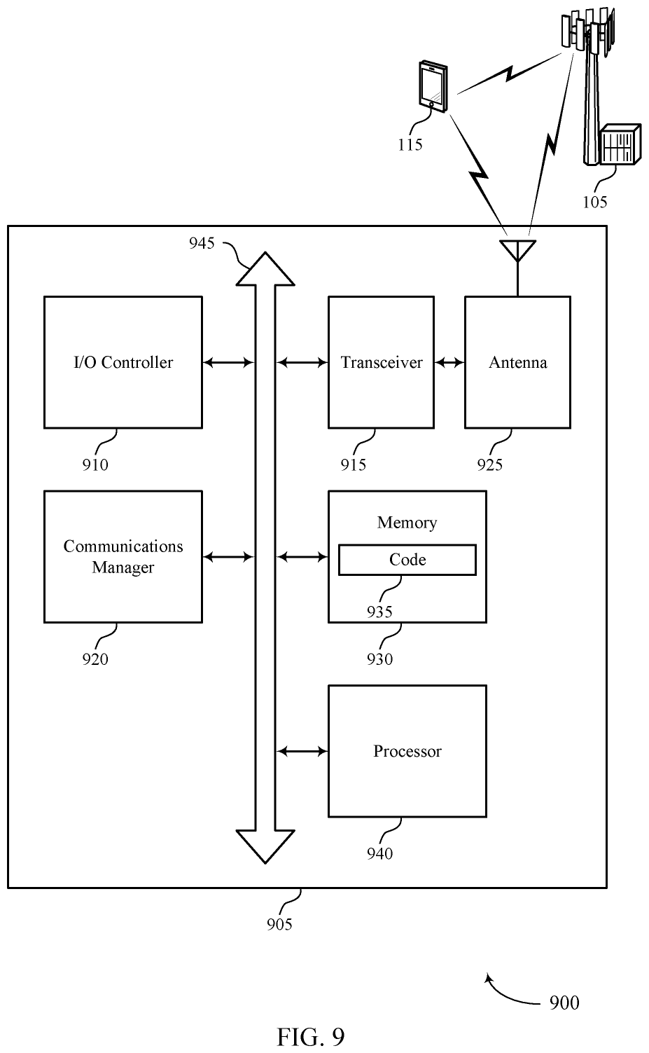

FIG. 9 shows a diagram of a system 900 including a device 905 that supports improving UE performance in CA scenarios in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting improving UE performance in CA scenarios). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein.

The communications manager 920 may support wireless communication in accordance with examples as disclosed herein. For example, the communications manager 920 is capable of, configured to, or operable to support a means for receiving control signaling indicating a CA configuration for a set of CCs, the set of CCs including at least a primary carrier configured for FDD communications and a secondary carrier configured for TDD communications. The communications manager 920 is capable of, configured to, or operable to support a means for monitoring one or more performance metrics associated with communications at the UE. The communications manager 920 is capable of, configured to, or operable to support a means for transmitting a UAI message indicating a request to modify a configured periodicity of SRS transmissions by the UE via the secondary carrier based on detecting that a performance metric of the one or more performance metrics satisfying a threshold value. The communications manager 920 is capable of, configured to, or operable to support a means for communicating, via the secondary carrier, one or more SRS transmissions according to a periodicity that is updated based on transmitting the UAI message.

Additionally, or alternatively, the communications manager 920 may support wireless communication in accordance with examples as disclosed herein. For example, the communications manager 920 is capable of, configured to, or operable to support a means for receiving control signaling indicating a CA configuration for a set of CCs for the UE, the set of CCs including at least a primary carrier configured for FDD communications and a secondary carrier configured for TDD communications. The communications manager 920 is capable of, configured to, or operable to support a means for transmitting, while operating in a first tracking area according to a first antenna switching capability of the UE, a first message requesting to perform a TAU procedure based on detecting that a performance metric associated with communications at the UE satisfies a threshold value, where the first antenna switching capability of the UE corresponds to a first quantity of receive antennas supported by the UE for communications via the secondary carrier, and where the first message indicates a TAI for the TAU procedure corresponding to the first tracking area. The communications manager 920 is capable of, configured to, or operable to support a means for receiving, in response to the first message, a request for the UE to indicate a capability of the UE. The communications manager 920 is capable of, configured to, or operable to support a means for transmitting, in response to the request, a second message indicating a second antenna switching capability of the UE based on adjusting the first antenna switching capability of the UE to the second antenna switching capability of the UE, the second antenna switching capability of the UE corresponding to a second quantity of receive antennas supported by the UE for communications via the secondary carrier, where the second quantity of receive antennas is less than the first quantity of receive antennas. The communications manager 920 is capable of, configured to, or operable to support a means for communicating, via the secondary carrier, one or more SRS transmissions in accordance with the second quantity of receive antennas.

Additionally, or alternatively, the communications manager 920 may support wireless communication in accordance with examples as disclosed herein. For example, the communications manager 920 is capable of, configured to, or operable to support a means for receiving control signaling indicating a CA configuration for a set of CCs, the set of CCs including at least a first carrier configured as a primary cell and a second carrier configured as a secondary cell, where the first carrier is configured for FDD communications and the second carrier is configured for TDD communications. The communications manager 920 is capable of, configured to, or operable to support a means for transmitting a measurement report based on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value. The communications manager 920 is capable of, configured to, or operable to support a means for receiving control signaling triggering a handover procedure to switch the primary cell to be associated with the second carrier and the secondary cell to be associated with the first carrier based on the measurement report including the second value corresponding to the second signal strength measurement plus the offset value. The communications manager 920 is capable of, configured to, or operable to support a means for communicating one or more SRS transmissions via the second carrier based on performing the handover procedure.

By including or configuring the communications manager 920 in accordance with examples as described herein, the device 905 may support techniques for improving channel estimation accuracy while avoiding performance degradation. The device 905 may reduce SRS transmission periodicity based on monitoring one or more performance metrics or conditions, thereby reducing how often SRS carrier switching is performed by the device 905. Performing SRS carrier switching less often may correspond to reduced switch times at the device 905, which, in turn, may reduce communications latency and improve communications efficiency.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of improving UE performance in CA scenarios as described herein, or the at least one processor 940 and the at least one memory 930 may be otherwise configured to, individually or collectively, perform or support such operations.

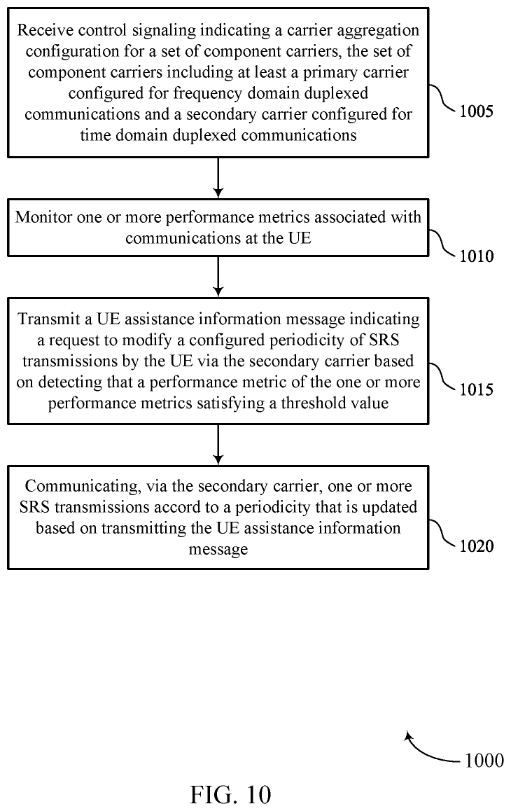

FIG. 10 shows a flowchart illustrating a method 1000 that supports improving UE performance in CA scenarios in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving control signaling indicating a CA configuration for a set of CCs, the set of CCs including at least a primary carrier configured for FDD communications and a secondary carrier configured for TDD communications. The operations of block 1005 may be performed in accordance with examples as disclosed herein. In some examples, aspects of the operations of 1005 may be performed by a CC component 825 as described with reference to FIG. 8.

At 1010, the method may include monitoring one or more performance metrics associated with communications at the UE. The operations of block 1010 may be performed in accordance with examples as disclosed herein. In some examples, aspects of the operations of 1010 may be performed by a performance metric component 830 as described with reference to FIG. 8.

At 1015, the method may include transmitting a UAI message indicating a request to modify a configured periodicity of SRS transmissions by the UE via the secondary carrier based on detecting that a performance metric of the one or more performance metrics satisfying a threshold value. The operations of block 1015 may be performed in accordance with examples as disclosed herein. In some examples, aspects of the operations of 1015 may be performed by a UAI component 835 as described with reference to FIG. 8.

At 1020, the method may include communicating, via the secondary carrier, one or more SRS transmissions according to a periodicity that is updated based on transmitting the UAI message. The operations of block 1020 may be performed in accordance with examples as disclosed herein. In some examples, aspects of the operations of 1020 may be performed by an SRS component 840 as described with reference to FIG. 8.

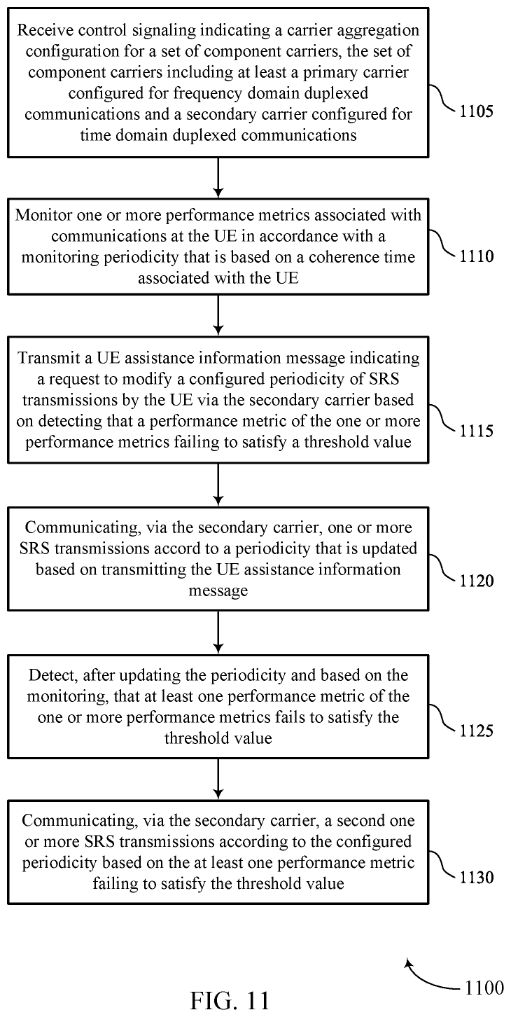

FIG. 11 shows a flowchart illustrating a method 1100 that supports improving UE performance in CA scenarios in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving control signaling indicating a CA configuration for a set of CCs, the set of CCs including at least a primary carrier configured for FDD communications and a secondary carrier configured for TDD communications. The operations of block 1105 may be performed in accordance with examples as disclosed herein. In some examples, aspects of the operations of 1105 may be performed by a CC component 825 as described with reference to FIG. 8.

At 1110, the method may include monitoring one or more performance metrics associated with communications at the UE in accordance with a monitoring periodicity that is based on a coherence time associated with the UE. The operations of block 1110 may be performed in accordance with examples as disclosed herein. In some examples, aspects of the operations of 1110 may be performed by a performance metric component 830 as described with reference to FIG. 8.

At 1115, the method may include transmitting a UAI message indicating a request to modify a configured periodicity of SRS transmissions by the UE via the secondary carrier based on detecting that a performance metric of the one or more performance metrics fails to satisfy a threshold value. The operations of block 1115 may be performed in accordance with examples as disclosed herein. In some examples, aspects of the operations of 1115 may be performed by a UAI component 835 as described with reference to FIG. 8.

At 1120, the method may include communicating, via the secondary carrier, one or more SRS transmissions according to a periodicity that is updated based on transmitting the UAI message. The operations of block 1120 may be performed in accordance with examples as disclosed herein. In some examples, aspects of the operations of 1120 may be performed by an SRS component 840 as described with reference to FIG. 8.

At 1125, the method may include detecting, after updating the periodicity and based on the monitoring, that at least one performance metric of the one or more performance metrics fails to satisfy the threshold value. The operations of block 1125 may be performed in accordance with examples as disclosed herein. In some examples, aspects of the operations of 1125 may be performed by a performance metric component 830 as described with reference to FIG. 8.

At 1130, the method may include communicating, via the secondary carrier, a second one or more SRS transmissions according to the configured periodicity based on the at least one performance metric failing to satisfy the threshold value. The operations of block 1130 may be performed in accordance with examples as disclosed herein. In some examples, aspects of the operations of 1130 may be performed by an SRS component 840 as described with reference to FIG. 8.

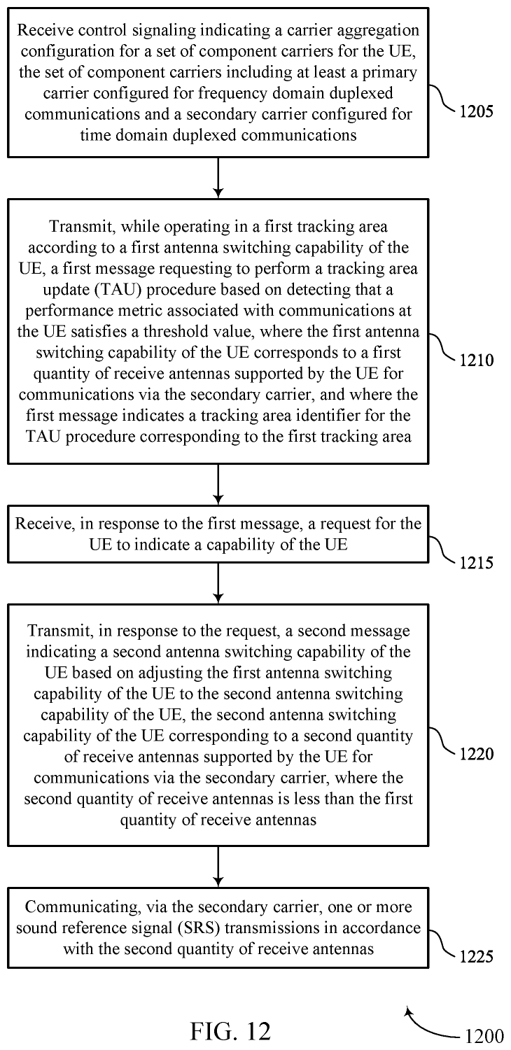

FIG. 12 shows a flowchart illustrating a method 1200 that supports improving UE performance in CA scenarios in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving control signaling indicating a CA configuration for a set of CCs for the UE, the set of CCs including at least a primary carrier configured for FDD communications and a secondary carrier configured for TDD communications. The operations of block 1205 may be performed in accordance with examples as disclosed herein. In some examples, aspects of the operations of 1205 may be performed by a CC component 825 as described with reference to FIG. 8.

At 1210, the method may include transmitting, while operating in a first tracking area according to a first antenna switching capability of the UE, a first message requesting to perform a TAU procedure based on detecting that a performance metric associated with communications at the UE satisfies a threshold value, where the first antenna switching capability of the UE corresponds to a first quantity of receive antennas supported by the UE for communications via the secondary carrier, and where the first message indicates a TAI for the TAU procedure corresponding to the first tracking area. The operations of block 1210 may be performed in accordance with examples as disclosed herein. In some examples, aspects of the operations of 1210 may be performed by a TA component 845 as described with reference to FIG. 8.

At 1215, the method may include receiving, in response to the first message, a request for the UE to indicate a capability of the UE. The operations of block 1215 may be performed in accordance with examples as disclosed herein. In some examples, aspects of the operations of 1215 may be performed by a capability component 850 as described with reference to FIG. 8.

At 1220, the method may include transmitting, in response to the request, a second message indicating a second antenna switching capability of the UE based on adjusting the first antenna switching capability of the UE to the second antenna switching capability of the UE, the second antenna switching capability of the UE corresponding to a second quantity of receive antennas supported by the UE for communications via the secondary carrier, where the second quantity of receive antennas is less than the first quantity of receive antennas. The operations of block 1220 may be performed in accordance with examples as disclosed herein. In some examples, aspects of the operations of 1220 may be performed by a capability component 850 as described with reference to FIG. 8.

At 1225, the method may include communicating, via the secondary carrier, one or more SRS transmissions in accordance with the second quantity of receive antennas. The operations of block 1225 may be performed in accordance with examples as disclosed herein. In some examples, aspects of the operations of 1225 may be performed by an SRS component 840 as described with reference to FIG. 8.

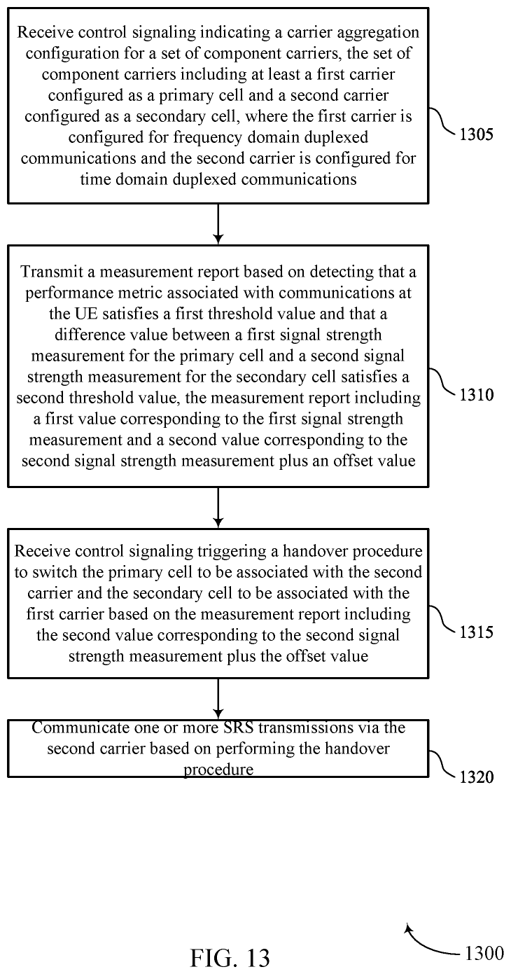

FIG. 13 shows a flowchart illustrating a method 1300 that supports improving UE performance in CA scenarios in accordance with aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating a CA configuration for a set of CCs, the set of CCs including at least a first carrier configured as a primary cell and a second carrier configured as a secondary cell, where the first carrier is configured for FDD communications and the second carrier is configured for TDD communications. The operations of block 1305 may be performed in accordance with examples as disclosed herein. In some examples, aspects of the operations of 1305 may be performed by a CC component 825 as described with reference to FIG. 8.

At 1310, the method may include transmitting a measurement report based on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value. The operations of block 1310 may be performed in accordance with examples as disclosed herein. In some examples, aspects of the operations of 1310 may be performed by a measurement report component 855 as described with reference to FIG. 8.

At 1315, the method may include receiving control signaling triggering a handover procedure to switch the primary cell to be associated with the second carrier and the secondary cell to be associated with the first carrier based on the measurement report including the second value corresponding to the second signal strength measurement plus the offset value. The operations of block 1315 may be performed in accordance with examples as disclosed herein. In some examples, aspects of the operations of 1315 may be performed by a handover component 860 as described with reference to FIG. 8.

At 1320, the method may include communicating one or more SRS transmissions via the second carrier based on performing the handover procedure. The operations of block 1320 may be performed in accordance with examples as disclosed herein. In some examples, aspects of the operations of 1320 may be performed by an SRS component 840 as described with reference to FIG. 8.

The following provides an overview of aspects of the present disclosure:
Aspect 1: A method for wireless communication by a UE, comprising: receiving control signaling indicating a CA configuration for a set of component carriers, the set of component carriers including at least a primary carrier configured for FDD communications and a secondary carrier configured for TDD communications; monitoring one or more performance metrics associated with communications at the UE; transmitting a UAI message indicating a request to modify a configured periodicity of SRS transmissions by the UE via the secondary carrier based at least in part on detecting that a performance metric of the one or more performance metrics satisfying a threshold value; and communicating, via the secondary carrier, one or more SRS transmissions according to a periodicity that is updated based at least in part on transmitting the UAI message.
Aspect 2: The method of aspect 1, wherein monitoring the one or more performance metrics comprises: monitoring the one or more performance metrics in accordance with a monitoring periodicity that is based at least in part on a coherence time associated with the UE.
Aspect 3: The method of aspect 2, further comprising: detecting, after updating the periodicity and based at least in part on the monitoring, that at least one performance metric of the one or more performance metrics fails to satisfy the threshold value; and communicating, via the secondary carrier, a second one or more SRS transmissions according to the configured periodicity based at least in part on the at least one performance metric failing to satisfy the threshold value.
Aspect 4: The method of aspect 2, further comprising: detecting, after updating the periodicity and based at least in part on the monitoring, that at least one performance metric of the one or more performance metrics fails to satisfy the threshold value; transmitting a second UAI message indicating a second request to update the periodicity of the SRS transmissions by the UE via the secondary carrier based at least in part on the at least one performance metric failing to satisfy the threshold value; and communicating, via the secondary carrier, a second one or more SRS transmissions according to a second periodicity that is updated based at least in part on transmitting the second UAI message.
Aspect 5: The method of aspect 4, wherein the second periodicity is the same as the configured periodicity.
Aspect 6: The method of any of aspects 1 through 5, further comprising: receiving, in response to transmitting the UAI message, a control message indicating the periodicity; and updating the configured periodicity to the periodicity based at least in part on receiving the control message.
Aspect 7: The method of any of aspects 1 through 6, wherein the one or more performance metrics comprise at least one of an uplink buffer size at the UE, a rate at which the uplink buffer size at the UE increases, a BLER associated with uplink communications at the UE, a path loss associated with the uplink communications at the UE, a downlink channel estimation obtained by the UE, a rank associated with downlink communications at the UE, an SNR associated with the UE, or a combination thereof, and the threshold value comprises at least one of a threshold uplink buffer size, a threshold rate at which the uplink buffer size at the UE increases, a threshold BLER associated with the uplink communications at the UE, a threshold path loss value associated with the uplink communications at the UE, a threshold downlink channel estimation value, a threshold rank value associated with the UE, a threshold SNR associated with the UE, or a combination thereof.
Aspect 8: The method of any of aspects 1 through 7, wherein the request to modify the configured periodicity comprises an indication of the periodicity.
Aspect 9: The method of any of aspects 1 through 7, wherein the request to modify the configured periodicity comprises a request to decrease the configured periodicity.
Aspect 10: The method of any of aspects 1 through 9, wherein the periodicity is less than the configured periodicity.
Aspect 11: A method for wireless communication by a UE, comprising: receiving control signaling indicating a CA configuration for a set of component carriers for the UE, the set of component carriers including at least a primary carrier configured for FDD communications and a secondary carrier configured for TDD communications; transmitting, while operating in a first tracking area according to a first antenna switching capability of the UE, a first message requesting to perform a TAU procedure based at least in part on detecting that a performance metric associated with communications at the UE satisfies a threshold value, wherein the first antenna switching capability of the UE corresponds to a first quantity of receive antennas supported by the UE for communications via the secondary carrier, and wherein the first message indicates a tracking area identifier for the TAU procedure corresponding to the first tracking area; receiving, in response to the first message, a request for the UE to indicate a capability of the UE; transmitting, in response to the request, a second message indicating a second antenna switching capability of the UE based at least in part on adjusting the first antenna switching capability of the UE to the second antenna switching capability of the UE, the second antenna switching capability of the UE corresponding to a second quantity of receive antennas supported by the UE for communications via the secondary carrier, wherein the second quantity of receive antennas is less than the first quantity of receive antennas; and communicating, via the secondary carrier, one or more SRS transmissions in accordance with the second quantity of receive antennas.
Aspect 12: The method of aspect 11, further comprising: monitoring one or more performance metrics including the performance metric to detect that the performance metric satisfies the threshold value, wherein the monitoring is in accordance with a monitoring periodicity that is based at least in part on a coherence time associated with the UE.
Aspect 13: The method of aspect 12, further comprising: detecting, after adjusting the first antenna switching capability of the UE to the second antenna switching capability of the UE and based at least in part on the monitoring, that at least one performance metric of the one or more performance metrics fails to satisfy the threshold value; adjusting the second antenna switching capability of the UE to the first antenna switching capability of the UE based at least in part on the at least one performance metric failing to satisfy the threshold value; and communicating, via the secondary carrier, a second one or more SRS transmissions in accordance with the first quantity of antennas.
Aspect 14: The method of any of aspects 11 through 13, wherein the performance metric comprises at least one of an uplink buffer size at the UE, a rate at which the uplink buffer size at the UE increases, a BLER associated with uplink communications at the UE, a path loss associated with the uplink communications at the UE, a downlink channel estimation obtained by the UE, a rank associated with downlink communications at the UE, an SNR associated with the UE, or a combination thereof, and the threshold value comprises at least one of a threshold uplink buffer size, a threshold rate at which the uplink buffer size at the UE increases, a threshold BLER associated with the uplink communications at the UE, a threshold path loss value associated with the uplink communications at the UE, a threshold downlink channel estimation value, a threshold rank value associated with the UE, a threshold SNR associated with the UE, or a combination thereof.
Aspect 15: A method for wireless communication by a UE, comprising: receiving control signaling indicating a CA configuration for a set of component carriers, the set of component carriers including at least a first carrier configured as a primary cell and a second carrier configured as a secondary cell, wherein the first carrier is configured for FDD communications and the second carrier is configured for TDD communications; transmitting a measurement report based at least in part on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value; receiving control signaling triggering a handover procedure to switch the primary cell to be associated with the second carrier and the secondary cell to be associated with the first carrier based at least in part on the measurement report including the second value corresponding to the second signal strength measurement plus the offset value; and communicating one or more SRS transmissions via the second carrier based at least in part on performing the handover procedure.
Aspect 16: The method of aspect 15, further comprising: monitoring one or more performance metrics including the performance metric to detect that the performance metric satisfies the first threshold value.
Aspect 17: The method of any of aspects 15 through 16, wherein the first signal strength measurement comprises a first ratio of an RSSI for the primary cell to an RSRP for the primary cell, the second signal strength measurement comprises a second ratio of an RSSI for the secondary cell to an RSRP for the secondary cell, and the difference value comprises a difference between the first ratio and the second ratio.
Aspect 18: The method of any of aspects 15 through 17, wherein the second value is greater than the first value.
Aspect 19: The method of aspect 18, wherein the first value comprises the first signal strength measurement minus a second offset value.
Aspect 20: The method of any of aspects 15 through 19, wherein the performance metric comprises at least one of an uplink buffer size at the UE, a rate at which the uplink buffer size at the UE increases, a BLER associated with uplink communications at the UE, a path loss associated with the uplink communications at the UE, a downlink channel estimation obtained by the UE, a rank associated with downlink communications at the UE, an SNR associated with the UE, or a combination thereof, and the first threshold value comprises at least one of a threshold uplink buffer size, a threshold rate at which the uplink buffer size at the UE increases, a threshold BLER associated with the uplink communications at the UE, a threshold path loss value associated with the uplink communications at the UE, a threshold downlink channel estimation value, a threshold rank value associated with the UE, a threshold SNR associated with the UE, or a combination thereof.
Aspect 21: A UE for wireless communication, comprising one or more memories storing processor-executable code, and one or more processors coupled with the one or more memories and individually or collectively operable to execute the code to cause the UE to perform a method of any of aspects 1 through 10.
Aspect 22: A UE for wireless communication, comprising at least one means for performing a method of any of aspects 1 through 10.
Aspect 23: A non-transitory computer-readable medium storing code for wireless communication, the code comprising instructions executable by at least one processor to perform a method of any of aspects 1 through 10.
Aspect 24: A UE for wireless communication, comprising one or more memories storing processor-executable code, and one or more processors coupled with the one or more memories and individually or collectively operable to execute the code to cause the UE to perform a method of any of aspects 11 through 14.
Aspect 25: A UE for wireless communication, comprising at least one means for performing a method of any of aspects 11 through 14.
Aspect 26: A non-transitory computer-readable medium storing code for wireless communication, the code comprising instructions executable by at least one processor to perform a method of any of aspects 11 through 14.
Aspect 27: A UE for wireless communication, comprising one or more memories storing processor-executable code, and one or more processors coupled with the one or more memories and individually or collectively operable to execute the code to cause the UE to perform a method of any of aspects 15 through 20.
Aspect 28: A UE for wireless communication, comprising at least one means for performing a method of any of aspects 15 through 20.
Aspect 29: A non-transitory computer-readable medium storing code for wireless communication, the code comprising instructions executable by at least one processor to perform a method of any of aspects 15 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware. software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating a carrier aggregation configuration for a set of component carriers, the set of component carriers including at least a primary carrier configured for frequency domain duplexed communications and a secondary carrier configured for time domain duplexed communications;
monitor one or more performance metrics associated with communications at the UE;
transmit a UE assistance information message indicating a request to modify a configured periodicity of sounding reference signal (SRS) transmissions by the UE via the secondary carrier based at least in part on detecting that a performance metric of the one or more performance metrics satisfying a threshold value; and
communicating, via the secondary carrier, one or more SRS transmissions accord to a periodicity that is updated based at least in part on transmitting the UE assistance information message.

2. The UE of claim 1, wherein, to monitor the one or more performance metrics, the one or more processors are individually or collectively operable to execute the code to cause the UE to:
monitor the one or more performance metrics in accordance with a monitoring periodicity that is based at least in part on a coherence time associated with the UE.

3. The UE of claim 2, wherein the one or more processors are individually or collectively further operable to execute the code to cause the UE to:
detect, after updating the periodicity and based at least in part on the monitoring, that at least one performance metric of the one or more performance metrics fails to satisfy the threshold value; and
communicating, via the secondary carrier, a second one or more SRS transmissions accord to the configured periodicity based at least in part on the at least one performance metric failing to satisfy the threshold value.

4. The UE of claim 2, wherein the one or more processors are individually or collectively further operable to execute the code to cause the UE to:
detect, after updating the periodicity and based at least in part on the monitoring, that at least one performance metric of the one or more performance metrics fails to satisfy the threshold value;
transmit a second UE assistance information message indicating a second request to update the periodicity of the SRS transmissions by the UE via the secondary carrier based at least in part on the at least one performance metric failing to satisfy the threshold value; and
communicating, via the secondary carrier, a second one or more SRS transmissions accord to a second periodicity that is updated based at least in part on transmitting the second UE assistance information message.

5. The UE of claim 4, wherein the second periodicity is the same as the configured periodicity.

6. The UE of claim 1, wherein the one or more processors are individually or collectively further operable to execute the code to cause the UE to:
receive, in response to transmitting the UE assistance information message, a control message indicating the periodicity; and
update the configured periodicity to the periodicity based at least in part on receiving the control message.

7. The UE of claim 1, wherein:
the one or more performance metrics comprise at least one of an uplink buffer size at the UE, a rate at which the uplink buffer size at the UE increases, a block error rate associated with uplink communications at the UE, a path loss associated with the uplink communications at the UE, a downlink channel estimation obtained by the UE, a rank associated with downlink communications at the UE, a signal-to-noise ratio associated with the UE, or a combination thereof, and
the threshold value comprises at least one of a threshold uplink buffer size, a threshold rate at which the uplink buffer size at the UE increases, a threshold block error rate associated with the uplink communications at the UE, a threshold path loss value associated with the uplink communications at the UE, a threshold downlink channel estimation value, a threshold rank value associated with the UE, a threshold signal-to-noise ratio associated with the UE, or a combination thereof.

8. The UE of claim 1, wherein the request to modify the configured periodicity comprises an indication of the periodicity.

9. The UE of claim 1, wherein the request to modify the configured periodicity comprises a request to decrease the configured periodicity.

10. The UE of claim 1, wherein the periodicity is less than the configured periodicity.

11. A user equipment (UE), comprising:
one or more memories storing processor-executable code; and
one or more processors coupled with the one or more memories and individually or collectively operable to execute the code to cause the UE to:
receive control signaling indicating a carrier aggregation configuration for a set of component carriers for the UE, the set of component carriers including at least a primary carrier configured for frequency domain duplexed communications and a secondary carrier configured for time domain duplexed communications;
transmit, while operating in a first tracking area according to a first antenna switching capability of the UE, a first message requesting to perform a tracking area update (TAU) procedure based at least in part on detecting that a performance metric associated with communications at the UE satisfies a threshold value, wherein the first antenna switching capability of the UE corresponds to a first quantity of receive antennas supported by the UE for communications via the secondary carrier, and wherein the first message indicates a tracking area identifier for the TAU procedure corresponding to the first tracking area;
receive, in response to the first message, a request for the UE to indicate a capability of the UE;
transmit, in response to the request, a second message indicating a second antenna switching capability of the UE based at least in part on adjusting the first antenna switching capability of the UE to the second antenna switching capability of the UE, the second antenna switching capability of the UE corresponding to a second quantity of receive antennas supported by the UE for communications via the secondary carrier, wherein the second quantity of receive antennas is less than the first quantity of receive antennas; and
communicating, via the secondary carrier, one or more sounding reference signal (SRS) transmissions in accordance with the second quantity of receive antennas.

12. The UE of claim 11, wherein the one or more processors are individually or collectively further operable to execute the code to cause the UE to:
monitor one or more performance metrics including the performance metric to detect that the performance metric satisfies the threshold value, wherein the monitoring is in accordance with a monitoring periodicity that is based at least in part on a coherence time associated with the UE.

13. The UE of claim 12, wherein the one or more processors are individually or collectively further operable to execute the code to cause the UE to:
detect, after adjusting the first antenna switching capability of the UE to the second antenna switching capability of the UE and based at least in part on the monitoring, that at least one performance metric of the one or more performance metrics fails to satisfy the threshold value;
adjust the second antenna switching capability of the UE to the first antenna switching capability of the UE based at least in part on the at least one performance metric failing to satisfy the threshold value; and
communicating, via the secondary carrier, a second one or more SRS transmissions in accordance with the first quantity of antennas.

14. The UE of claim 11, wherein:
the performance metric comprises at least one of an uplink buffer size at the UE, a rate at which the uplink buffer size at the UE increases, a block error rate associated with uplink communications at the UE, a path loss associated with the uplink communications at the UE, a downlink channel estimation obtained by the UE, a rank associated with downlink communications at the UE, a signal-to-noise ratio associated with the UE, or a combination thereof, and
the threshold value comprises at least one of a threshold uplink buffer size, a threshold rate at which the uplink buffer size at the UE increases, a threshold block error rate associated with the uplink communications at the UE, a threshold path loss value associated with the uplink communications at the UE, a threshold downlink channel estimation value, a threshold rank value associated with the UE, a threshold signal-to-noise ratio associated with the UE, or a combination thereof.

15. A user equipment (UE), comprising:
one or more memories storing processor-executable code; and
one or more processors coupled with the one or more memories and individually or collectively operable to execute the code to cause the UE to:
receive control signaling indicating a carrier aggregation configuration for a set of component carriers, the set of component carriers including at least a first carrier configured as a primary cell and a second carrier configured as a secondary cell, wherein the first carrier is configured for frequency domain duplexed communications and the second carrier is configured for time domain duplexed communications;
transmit a measurement report based at least in part on detecting that a performance metric associated with communications at the UE satisfies a first threshold value and that a difference value between a first signal strength measurement for the primary cell and a second signal strength measurement for the secondary cell satisfies a second threshold value, the measurement report including a first value corresponding to the first signal strength measurement and a second value corresponding to the second signal strength measurement plus an offset value;
receive control signaling triggering a handover procedure to switch the primary cell to be associated with the second carrier and the secondary cell to be associated with the first carrier based at least in part on the measurement report including the second value corresponding to the second signal strength measurement plus the offset value; and
communicate one or more sounding reference signal (SRS) transmissions via the second carrier based at least in part on performing the handover procedure.

16. The UE of claim 15, wherein the one or more processors are individually or collectively further operable to execute the code to cause the UE to:
monitor one or more performance metrics including the performance metric to detect that the performance metric satisfies the first threshold value.

17. The UE of claim 15, wherein:
the first signal strength measurement comprises a first ratio of a received signal strength indicator (RSSI) for the primary cell to a reference signal received power (RSRP) for the primary cell,
the second signal strength measurement comprises a second ratio of an RSSI for the secondary cell to an RSRP for the secondary cell, and
the difference value comprises a difference between the first ratio and the second ratio.

18. The UE of claim 15, wherein the second value is greater than the first value.

19. The UE of claim 18, wherein the first value comprises the first signal strength measurement minus a second offset value.

20. The UE of claim 15, wherein:
the performance metric comprises at least one of an uplink buffer size at the UE, a rate at which the uplink buffer size at the UE increases, a block error rate associated with uplink communications at the UE, a path loss associated with the uplink communications at the UE, a downlink channel estimation obtained by the UE, a rank associated with downlink communications at the UE, a signal-to-noise ratio associated with the UE, or a combination thereof, and
the first threshold value comprises at least one of a threshold uplink buffer size, a threshold rate at which the uplink buffer size at the UE increases, a threshold block error rate associated with the uplink communications at the UE, a threshold path loss value associated with the uplink communications at the UE, a threshold downlink channel estimation value, a threshold rank value associated with the UE, a threshold signal-to-noise ratio associated with the UE, or a combination thereof.

21. A method for wireless communication by a user equipment (UE), comprising:
receiving control signaling indicating a carrier aggregation configuration for a set of component carriers, the set of component carriers including at least a primary carrier configured for frequency domain duplexed communications and a secondary carrier configured for time domain duplexed communications;
monitoring one or more performance metrics associated with communications at the UE;
transmitting a UE assistance information message indicating a request to modify a configured periodicity of sounding reference signal (SRS) transmissions by the UE via the secondary carrier based at least in part on detecting that a performance metric of the one or more performance metrics satisfying a threshold value; and
communicating, via the secondary carrier, one or more SRS transmissions according to a periodicity that is updated based at least in part on transmitting the UE assistance information message.

22. The method of claim 21, wherein monitoring the one or more performance metrics comprises:
monitoring the one or more performance metrics in accordance with a monitoring periodicity that is based at least in part on a coherence time associated with the UE.

23. The method of claim 22, further comprising:
detecting, after updating the periodicity and based at least in part on the monitoring, that at least one performance metric of the one or more performance metrics fails to satisfy the threshold value; and
communicating, via the secondary carrier, a second one or more SRS transmissions according to the configured periodicity based at least in part on the at least one performance metric failing to satisfy the threshold value.

24. The method of claim 22, further comprising:
detecting, after updating the periodicity and based at least in part on the monitoring, that at least one performance metric of the one or more performance metrics fails to satisfy the threshold value;
transmitting a second UE assistance information message indicating a second request to update the periodicity of the SRS transmissions by the UE via the secondary carrier based at least in part on the at least one performance metric failing to satisfy the threshold value; and
communicating, via the secondary carrier, a second one or more SRS transmissions according to a second periodicity that is updated based at least in part on transmitting the second UE assistance information message.

25. The method of claim 24, wherein the second periodicity is the same as the configured periodicity.

26. The method of claim 21, further comprising:
receiving, in response to transmitting the UE assistance information message, a control message indicating the periodicity; and
updating the configured periodicity to the periodicity based at least in part on receiving the control message.

27. The method of claim 21, wherein:
the one or more performance metrics comprise at least one of an uplink buffer size at the UE, a rate at which the uplink buffer size at the UE increases, a block error rate associated with uplink communications at the UE, a path loss associated with the uplink communications at the UE, a downlink channel estimation obtained by the UE, a rank associated with downlink communications at the UE, a signal-to-noise ratio associated with the UE, or a combination thereof, and
the threshold value comprises at least one of a threshold uplink buffer size, a threshold rate at which the uplink buffer size at the UE increases, a threshold block error rate associated with the uplink communications at the UE, a threshold path loss value associated with the uplink communications at the UE, a threshold downlink channel estimation value, a threshold rank value associated with the UE, a threshold signal-to-noise ratio associated with the UE, or a combination thereof.

28. The method of claim 21, wherein the request to modify the configured periodicity comprises an indication of the periodicity.

29. The method of claim 21, wherein the request to modify the configured periodicity comprises a request to decrease the configured periodicity.

30. The method of claim 21, wherein the periodicity is less than the configured periodicity.
